(19) United States
(12) Patent Application Publication
(10) Pub. No.: US 2006/0278756 A1
(43) Pub. Date: Dec. 14, 2006

(54) Airplane tug

(76) Inventor: Aaron Marshall, Waukesha, WI (US)

Correspondence Address: MICHAEL BEST & FRIEDRICH, LLP, 100 E WISCONSIN AVENUE, MILWAUKEE, WI, 53202, US

(21) Appl. No.: 11/418,739

(22) Filed: May 5, 2006

Related U.S. Application Data
(60) Provisional application No. 60/677,869, filed on May 5, 2005.

(51) Int. Cl. B64C 25/50

(52) U.S. Cl. 244/50

(57) ABSTRACT

A tug operable to move an airplane. The airplane includes an airplane wheel, the tug may include a frame, a wheel supporting the frame for movement over ground, and a retainer assembly supported by the frame and engageable with the airplane wheel to connect the tug and the airplane. The retainer assembly may be configurable in a loading condition, in which the airplane wheel is loaded onto and off of the tug, and in a retaining condition, in which the airplane wheel is retained on the tug. The retainer assembly may include a first wall engageable with a front portion of the airplane wheel to limit movement of the airplane wheel relative to the tug in the direction of the first wall, and a second wall positionable in an engaging position, in which the second wall is engageable with a rear portion of the airplane wheel to limit movement of the airplane wheel relative to the tug in the direction of the second wall, and in a ramp position, in which the second wall provides a ramp portion, the airplane wheel being movable on the ramp portion onto and off of the tug.

### RELATED APPLICATIONS

This patent application claims priority to prior-filed co-pending U.S. Provisional Patent Application Ser. No. 60/677,869, filed May 5, 2005, the entire contents of which is hereby incorporated by reference.

### FIELD OF THE INVENTION

The present invention generally relates to transport apparatus and, more particularly, to a tug for transporting a vehicle such as an airplane.

### SUMMARY

Existing airplane tug designs require the operator to physically intervene in some manner to secure the wheel once loaded onto the tug/tow vehicle. For example, one existing tug requires a strap to be placed around the front strut and winched tight to secure the aircraft and tug together. Another existing tug design requires a plate to be placed behind the tire and the front wheel jacked clear of the ground. Other existing tug designs utilize a series of levers, cables, springs, and or pushrods to expand pins which clamp to the aircraft landing gear assembly to accomplish coupling the two vehicles.

Existing walk behind or riding vehicles used for pushing or pulling aircraft employ a variety of capturing/connecting mechanisms such as horizontally expanding/contracting pins inserted into the wheel axle or tow pins. With such constructions, the operator must move handles, or physically place the pins and then latch them in order to secure the aircraft to the tug. Other existing models scoop the aircraft wheel up onto a tilting platform and require the nose strut to be secured to the tug under tension by way of a strap winched under tension to the tug itself. After driving the vehicle under the wheel, the operator must wrap a strap around the strut, hook it to the onboard winch and pull the aircraft forward toe the stop with the crank.

All of these devices require physical intervention by the operator to secure the aircraft to the tug. Nose wheels and struts are inherently greasy and dirty. Straps and pins can be awkward and clumsy to install without getting dirty. Securing the aircraft usually involves bending down and crouching, as well as moving in close proximity to aircraft propeller or nose cone which may result in contact between the operator and a portion of the aircraft (e.g., a head strike) sooner or later. Most existing designs cannot accommodate both nose wheel and tail wheel aircraft without modification.

An independent feature of the airplane tug design of the present invention is the wheel capture bucket and the relatively simple loading design.

In some independent aspects, the design requires no operator intervention as the bucket tips forward to form a ramp for the nose wheel to roll up and onto the platform as the tug is driven into, and beneath the aircraft wheel.

In some constructions, the bucket base sits above the ground, and the front lip of the ramp, formed by the bucket when tipped, is prevented from touching the ground so as to come to rest, for example, approximately ¼″ to ½″ above the ground. This prevents or limits contact damage to painted floors as well as problems from debris being scooped or scraped by the front of the bucket.

In some constructions, the front of the bucket may include a roller in order to assist the wheel in rolling up onto the ramp formed by the forward tipped bucket.

In operation, the operator propels the tug under the wheel in a scooping fashion. Driving the vehicle under the wheel causes the wheel to roll up the ramp formed by the forward tipped bucket. As the aircraft wheel passes the fulcrum of the bucket where hinged beneath, the bucket automatically tips back and latches securely. The bucket may be secured in the upright/locked position by means of a latch with release handle.

Unloading is accomplished by releasing the bucket latch, reversing the tug, and backing the tug out from under the aircraft while leaving the aircraft in the desired spot without rolling back or changing location.

The bucket may be made of metal, such as steel, and hinged at the base. The bucket shape may provide both a containment device, to keep the wheel in place during movement, as well as a ramp, for raising the wheel from ground level to the tug frame level for movement.

Driven by the operator, the tug automatically loads and latches the aircraft into position readying it for movement. After positioning the airplane is complete, the latch is remotely released by the operator and the carriage bucket transitions to a ramp for unloading. The aircraft remains in place as the tug is backed out so that the airplane does not go beyond where it was intended to be parked.

In some independent aspects, the present tug design can move either tricycle gear aircraft or conventional gear aircraft without modification, unlike existing designs that require adapters for different aircraft or that are simply too tall to move beneath the fuselage or elevators of conventional gear aircraft without contacting and/or damaging the aircraft.

In some independent aspects, the present tug design allows the operator to load, move and unload the aircraft without ever leaving the driving position to intervene, or manually actuating any latching devices. In some independent aspects, the present design consists of a uniquely shaped bucket with at least three sides. The bucket is hinged at the base so as to rotate fore and aft. The bucket may be prevented from contacting the ground by stops, so as not to scrape painted floors or collect debris such as rocks or gravel. A roller at the aircraft wheel contact point of the bucket assists in loading. The bucket may be latched to the vehicle frame for aircraft movement when the tug is propelled into and under the aircraft wheel scooping the wheel up onto the front panel of the bucket (the ramp face), rolling up the incline created by the opened bucket, tipping the bucket over center as the wheel reaches the deck level of the tug and causing the striker to slam into the latching mechanism thereby securing the bucket to the tug for aircraft movement.

After desired positioning, the operator releases the latch by means of a remote handle, reverses the tug and the aircraft wheel rolls down the ramp and in position on the floor. Since the tug moves forward and back, and the aircraft wheel rolls, the aircraft does not move during loading and unloading allowing for precise positioning with no rollback during unloading as with other designs.

The tug propulsion system of the present design may have soft start and acceleration settings so as to prevent aircraft from rolling up and out of the bucket for aircraft with high static inertia.

In some independent aspects and in some constructions, a transport apparatus may include a walk behind vehicle or a riding vehicle. The apparatus may generally include a motor, a drive axle, at least two wheels and a securing device for capturing and retaining aircraft nose wheel or tail wheel during aircraft repositioning.

In some independent aspects and in some constructions, the securing device may generally include a bucket with an angled front (e.g., approximately 70 degrees) which is hinged at the base so as to be able to tip forward forming a ramp. The bucket may be prevented from touching the ground when in the load/unload position. The bucket may be positively latched when in the upright position and may be unlatched by operator moving a release mechanism.

Independent aspects and independent features of the invention will become apparent by consideration of the detailed description, claims and accompanying drawings.

### BRIEF DESCRIPTION OF THE DRAWINGS

FIG. 1 is a front perspective view of a transport apparatus, such as an airplane tug.

FIG. 2 is a side view of the tug shown in FIG. 1.

FIG. 3 is an enlarged side view of a portion of the tug shown in FIG. 1.

FIG. 4 is a front perspective view of the tug shown in FIG. 1.

FIG. 5 is an enlarged side view of a portion of the tug shown in FIG. 1.

FIG. 6 is an enlarged perspective view of a portion of the tug shown in FIG. 1 and illustrating loading of an airplane wheel onto the tug.

FIG. 7 is a perspective view of the tug shown in FIG. 1 and illustrating an airplane wheel loaded onto the tug.

FIG. 8 is a perspective view of the tug shown in FIG. 1 and illustrating loading of an airplane wheel onto the tug.

FIG. 9 is an enlarged perspective view of a portion of the tug shown in FIG. 1 and illustrating loading of an airplane wheel onto the tug.

FIG. 10 is an enlarged perspective view of a portion the tug shown in FIG. 1 and illustrating loading of an airplane wheel onto the tug.

FIG. 11 is a perspective view of the tug shown in FIG. 1 and illustrating an airplane wheel loaded onto the tug.

FIG. 12 is a perspective view of the tug shown in FIG. 1 and illustrating an airplane wheel loaded onto the tug.

FIGS. 13-31 are views of an alternate construction of a transport apparatus, such as an airplane tug.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

A transport apparatus, such as a tug 10 for transporting a vehicle such as an airplane A, is illustrated in the figures. The tug 10 includes a frame 14 supported by wheels 18 and 22 for movement over ground. In the illustrated construction, the tug 10 is a walk-behind vehicle. In other constructions (not shown), the tug 10 may be a riding vehicle and would include structure to support the operator during movement of the tug 10.

A drive system 26 is supported by the frame 14 and is connected through a transaxle 74 to drive the wheels 18. In the illustrated constructions, the drive system 26 includes an electric motor 28 which is selectively powered by one or more batteries 30. A battery charger 38 may be included to re-charge the batteries 30. A handle 40 with input controls 42 is manipulated by the operator to drive the tug 10 in forward and reverse directions and to turn the tug 10.

In the illustrated construction, a controller 34 controls operation of the motor 28 and/or drive system 26 (e.g., power, speed, direction (forward, reverse, turn left, turn right), motor operation characteristics (e.g., soft start, acceleration, etc.), etc.). Control of motor operation characteristics, such as soft start, smoothed acceleration, etc., may improve operation of the tug 10 by limiting the potential for de-coupling of the airplane A from the tug 10 as the tug 10 begins to move, during transport of the airplane A, etc.

In other constructions (not shown), the drive system 26 may include another type of motor powered by another power source (e.g., fuel).

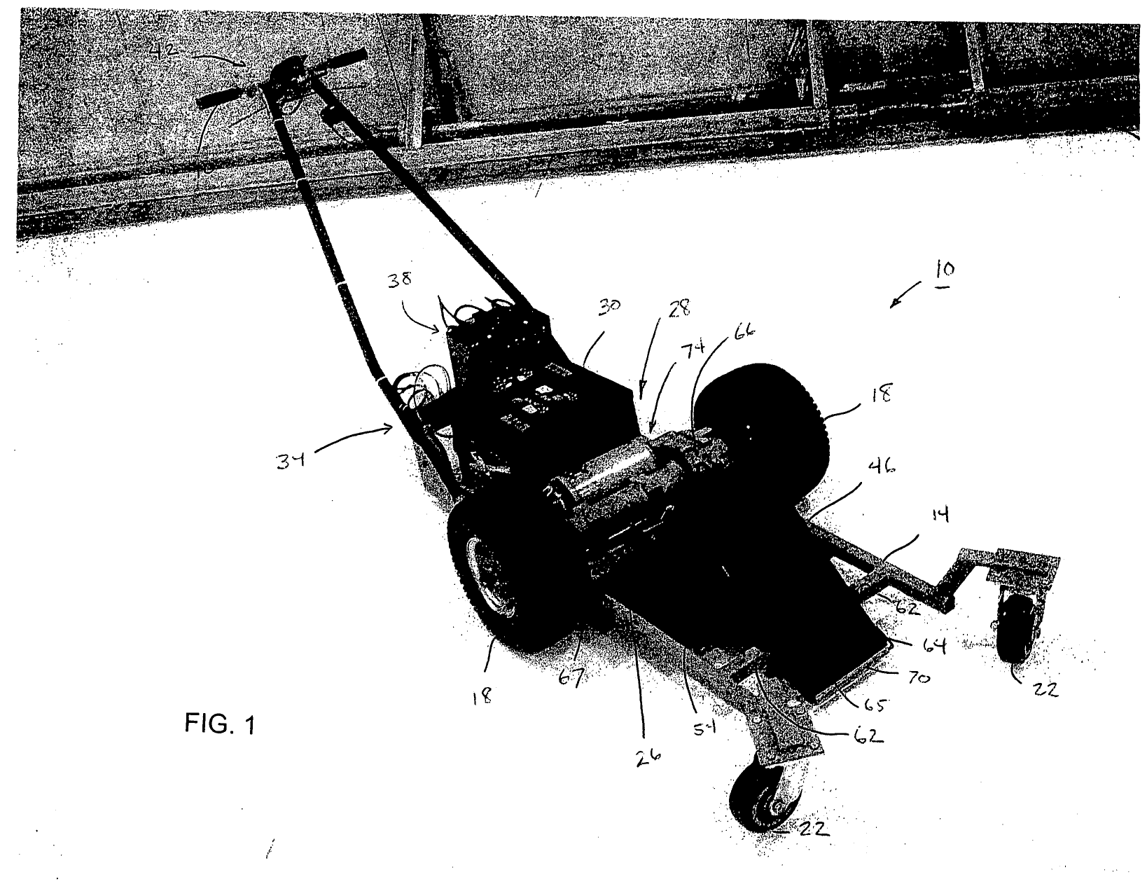

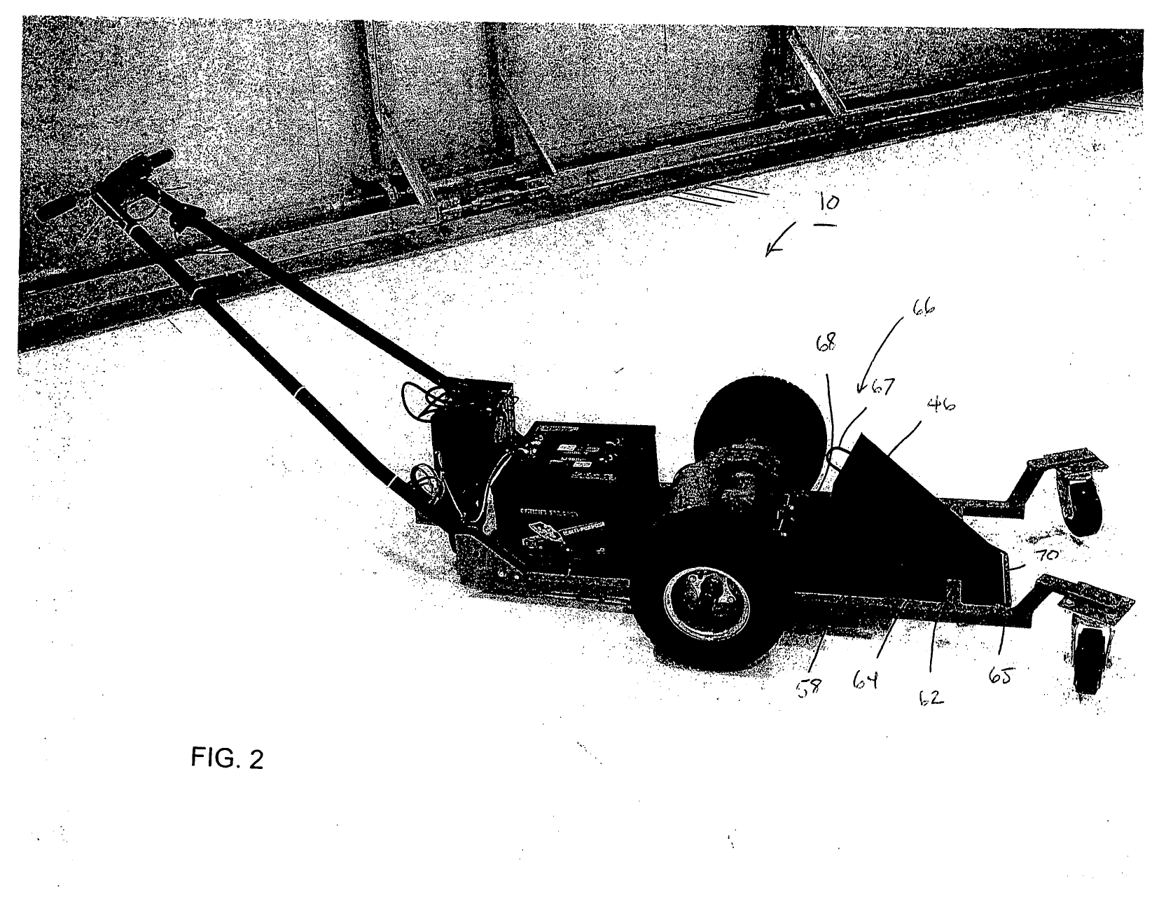

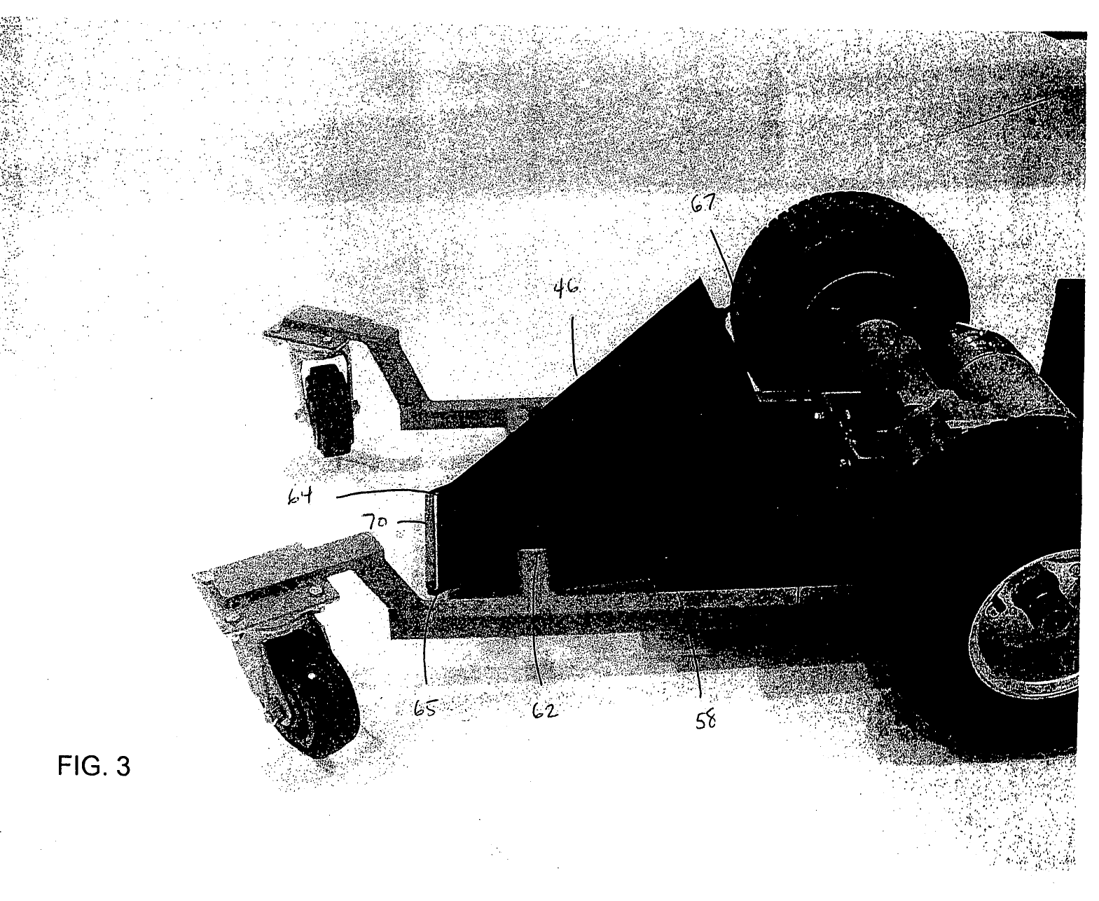

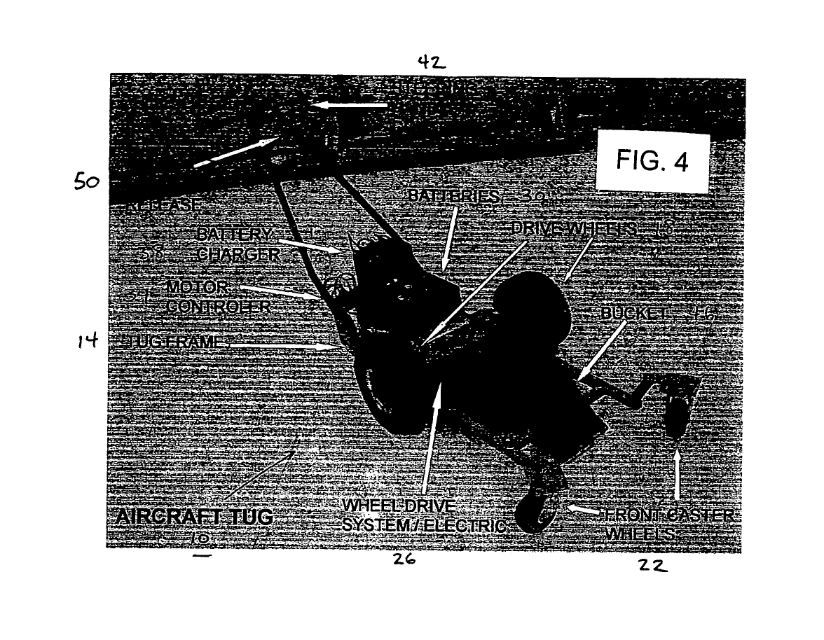

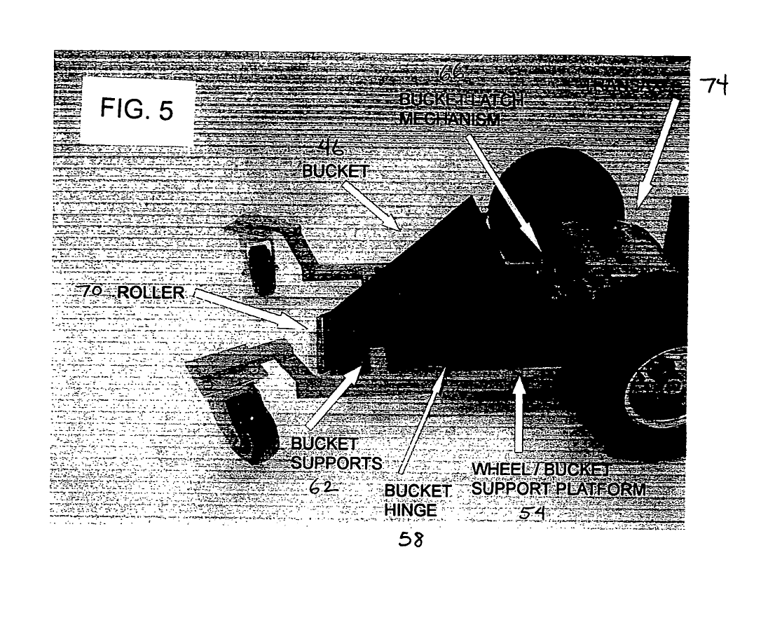

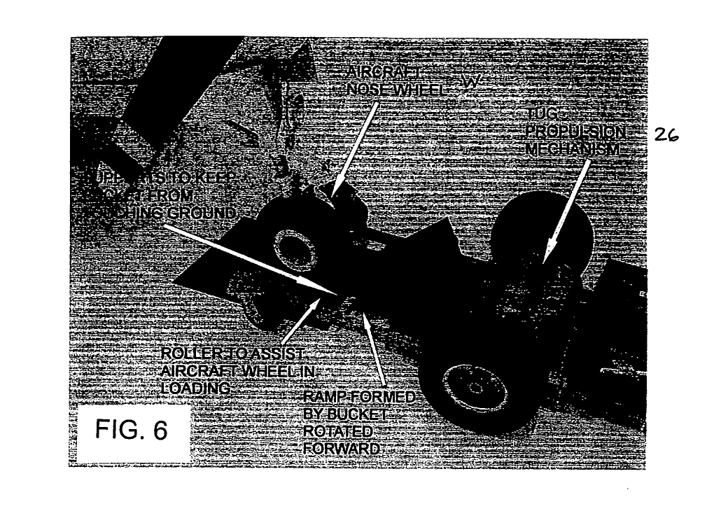

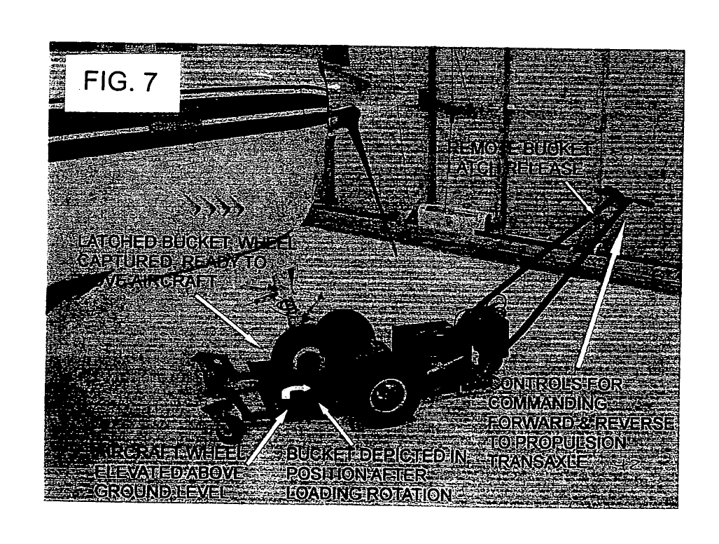

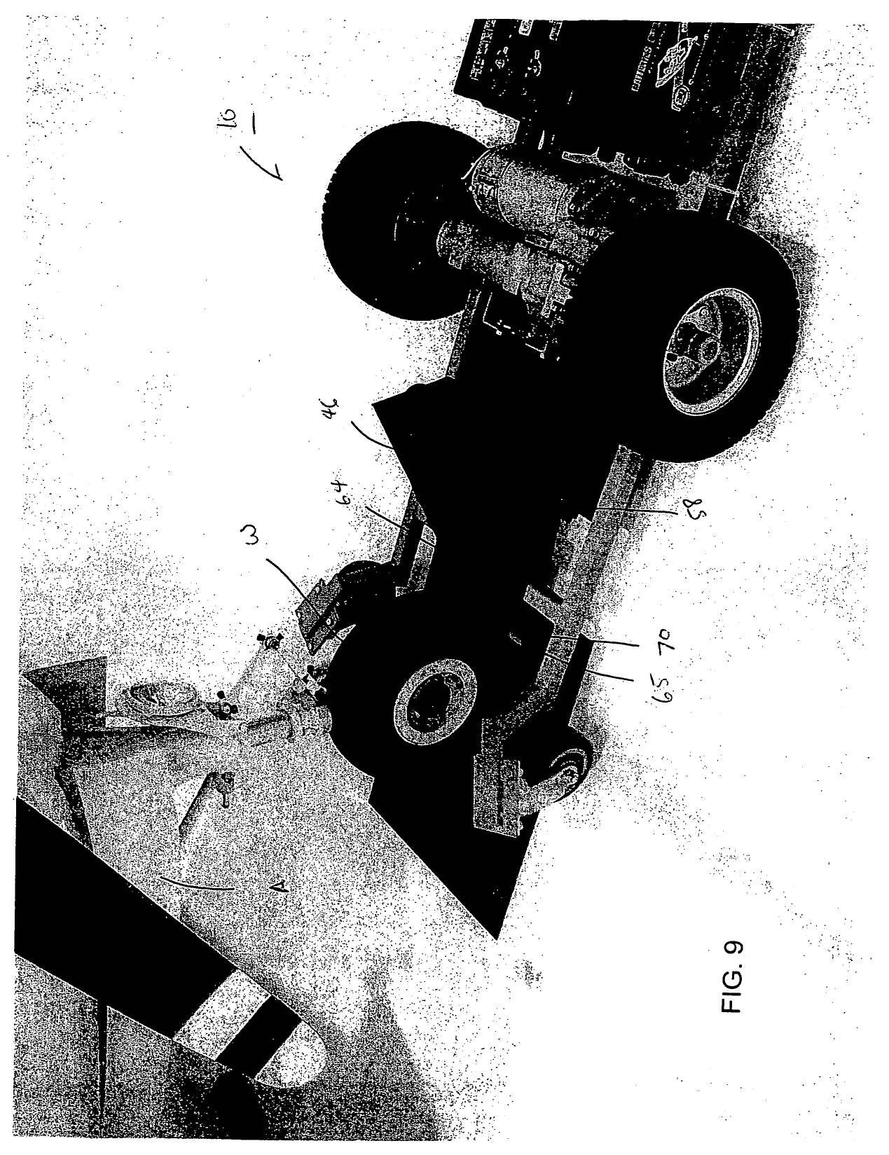

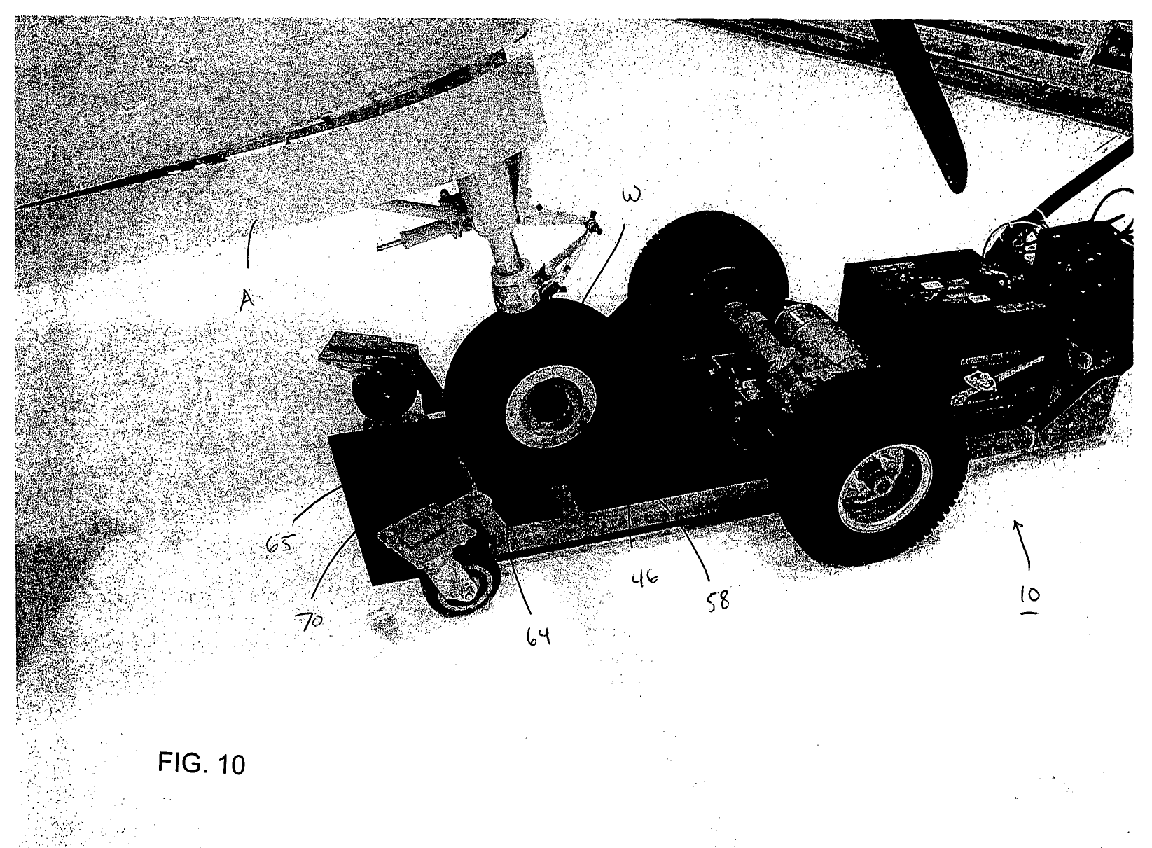

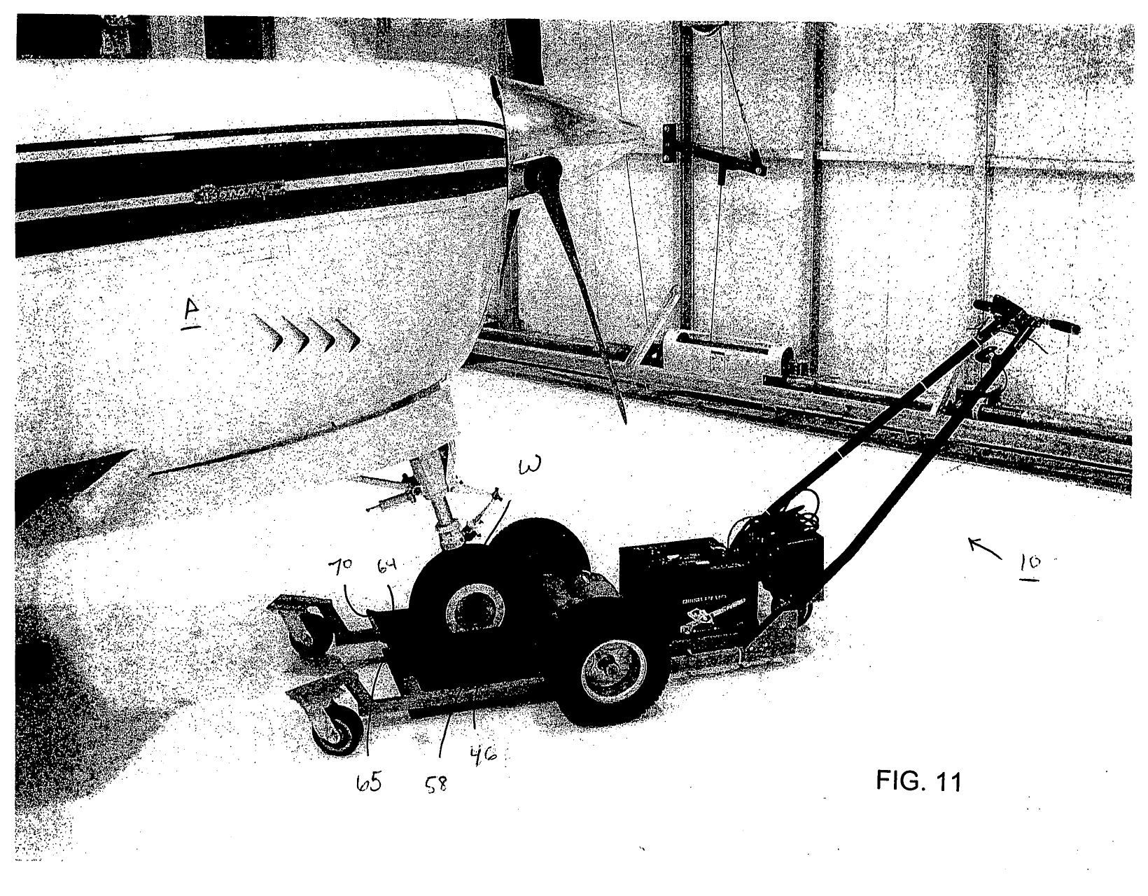

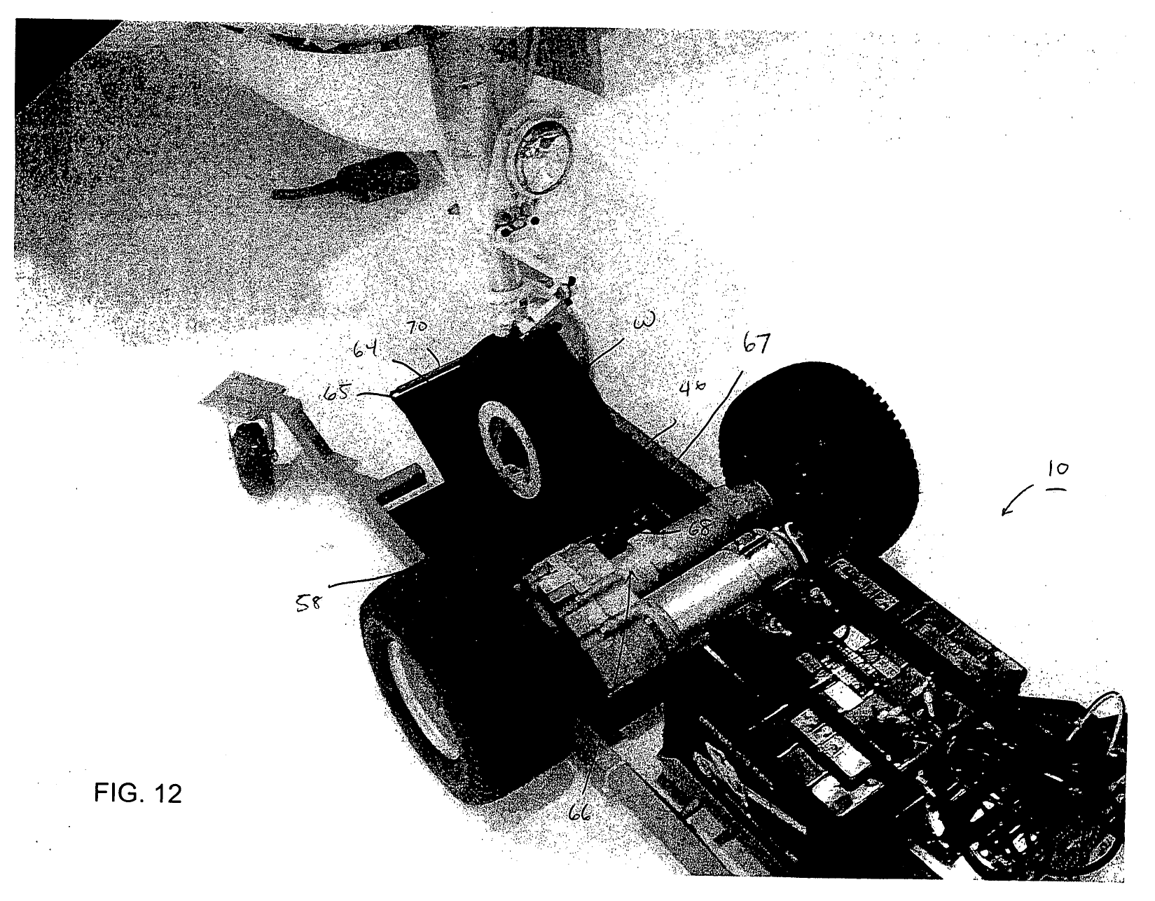

A wheel capture/containment/retainer assembly including a bucket 46 is attached to the frame 14 on a support platform 54. A hinge 58 allows the bucket 46 to pivot freely fore and aft between a loading position (see FIGS. 1-6 and 8-10), in which the wheel W is loaded onto and off of the tug 10, and a retaining position (see FIGS. 7 and 11-12), in which the wheel W is retained on the tug 10. Bucket supports 62 limit the pivoting movement of the bucket 46 and, in some constructions, maintain the bucket 46 above the ground (see FIGS. 2-3) in the lowered pivoted position.

In the illustrated construction, the bucket 46 sits above the ground, and the front lip 64 of the ramp 65, formed by the bucket 46 when tipped, is prevented from touching the ground so as to come to rest, for example, approximately ¼″ to ½″ above the ground (see FIGS. 1-6 and 8-10). This prevents or limits contact damage to painted floors as well as problems from debris being scooped or scraped by the front of the bucket 46. In the illustrated construction, the front of the bucket 46 includes a roller 70 in order to assist the wheel W in rolling up onto the ramp 65 formed by the forward-tipped bucket 46.

In the illustrated construction, the bucket supports 62 are fixed so that the distance the front lip 65 of the bucket 46 and roller 70 sit above the ground is fixed. In other constructions (not shown), an arrangement may be provided to allow for adjustment of this clearance distance. For example, bolts (not shown) may be threadedly supported in the bucket supports 62. Adjustment of the bolts changes the height at which the bucket 46 is prevented from further pivoting movement. Other types of movable stops may be provided between the frame 14 and the bucket 46 to provide the adjustable clearance.

The bucket 46 may be made of metal, such as steel, and hinged at the base. The bucket 46 shape may provide both a containment device, to keep the wheel W in place during movement, as well as a ramp 65, for raising the wheel W from ground level to the tug frame level for movement.

The containment bucket 46 function is unique in that the bucket 46 pivots fore and aft as the airplane wheel W passes the center of gravity determined by the fixed hinge 58 tying the base of the bucket 46 to the tug frame 14. The containment bucket 46 tips fore and aft in concert with the forward and backward motion of the tug 10.

A latching mechanism 66 is operable to capture and hold the bucket 46 in a fixed position (e.g., the raised, pivoted retaining position) until released by the vehicle operator. A release mechanism 50 is supported on the handle 40 and is operable to unlatch the containment bucket 46 for de-coupling the aircraft A and tug 10. In the illustrated construction, the containment bucket 46 connects to the latching mechanism 66 by means of a striker 67 held by the latch 68 until released.

In other constructions (not shown), another type of latching structure (e.g., electrical, magnetic, another mechanical structure, etc.) to prevent unwanted movement of the bucket 46 may be provided. In yet other constructions (not shown), another arrangement which does not include “latching” structure may be provided to prevent unwanted movement of the bucket 46. For example, structure may be provided to releasably engage another portion of the bucket 46 (e.g., the front of the bucket 46) to maintain the bucket 46 in the upright position. As another example, structure (e.g., mechanical, electrical, magnetic, etc.) may be provided on the hinge portion to selectively prevent pivoting movement about the hinge 58.

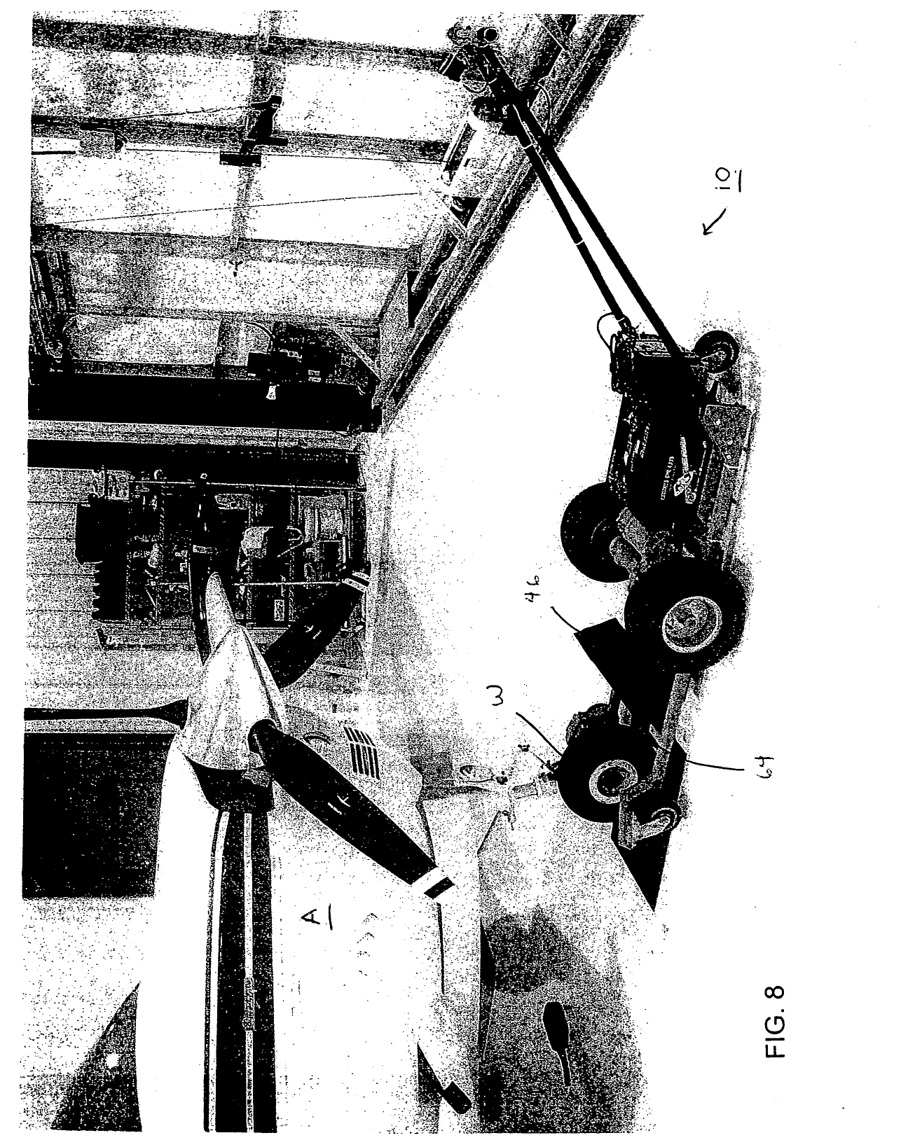

In operation, the tug 10 is propelled (e.g., by the drive system 26, by the operator, etc.) under the wheel W in a scooping fashion. As shown in FIGS. 8-10, driving the bucket 46 under the wheel W causes the wheel W to roll up the ramp formed by the forward-tipped bucket 46. As the aircraft wheel W passes the fulcrum of the bucket 46 where hinged beneath, the bucket 46 automatically tips back and latches securely (in the position shown in FIGS. 7 and 11-12). The bucket 46 may be secured in the upright/locked retaining position by the latching mechanism 66.

Unloading is accomplished by releasing the bucket latching mechanism 66, reversing and backing the tug 10 out from under the aircraft A while leaving the aircraft A in the desired spot without rolling back or changing location. As the aircraft wheel W passes the fulcrum beneath the bucket 46, the bucket 46 automatically tips downwardly to provide the ramp 65.

Driven by the operator, the tug 10 automatically loads and latches the aircraft A into position readying it for movement. After positioning of the airplane A is complete, the operator operates the latching mechanism 66 to remotely release the latch, and the carriage bucket 46 transitions to a ramp for unloading. The aircraft A remains in place as the tug 10 is backed out so that the airplane A does not go beyond where it was intended to be parked.

The tug 10 moves only when commanded by the controls and, in the illustrated construction, does not roll freely. This allows precise control of the bucket tip angle as it approaches and passes the over-center position. The unique design of this bucket 46 in conjunction with extremely fine control of the tug motion allows the aircraft A to be loaded and unloaded without moving the airplane A itself until fully loaded in on the tug 10. In contrast, with existing designs, the operator may have to guess where the aircraft will end up when the aircraft rolls off the existing tug platform.

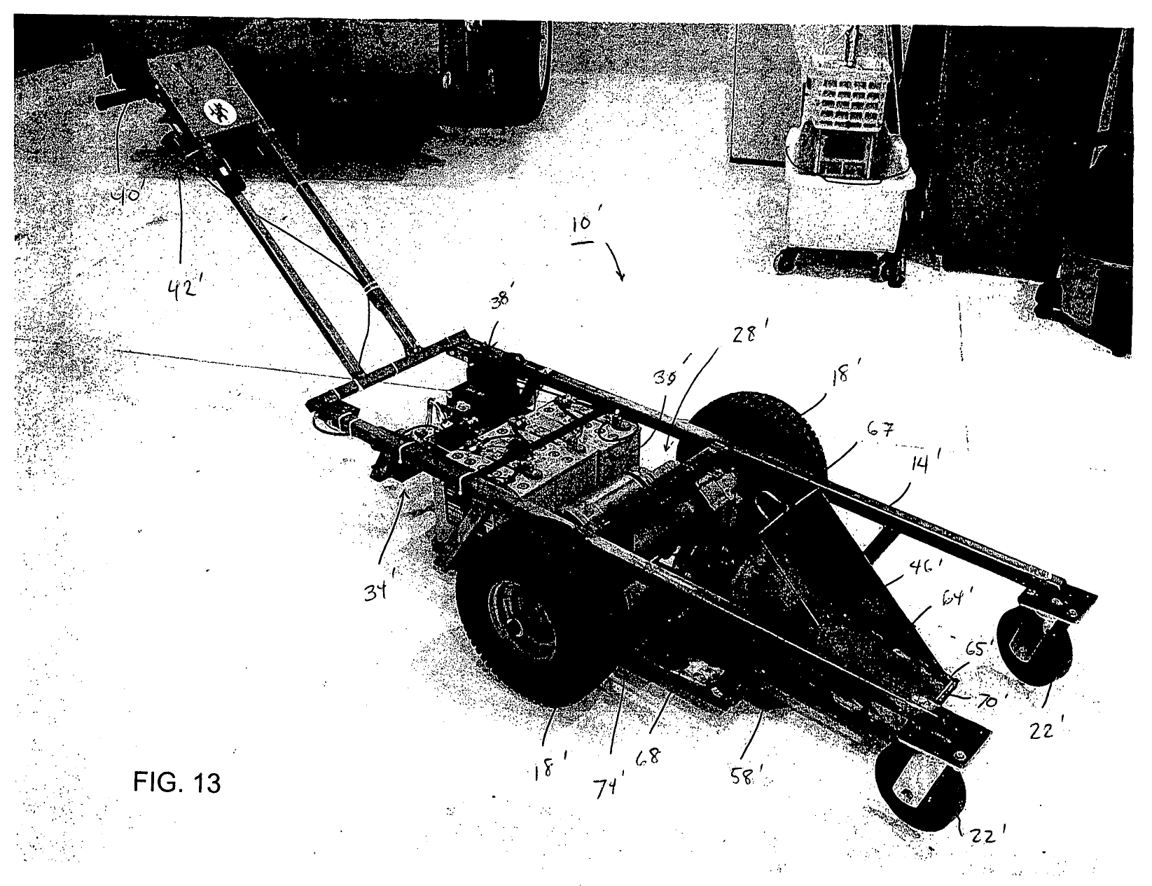

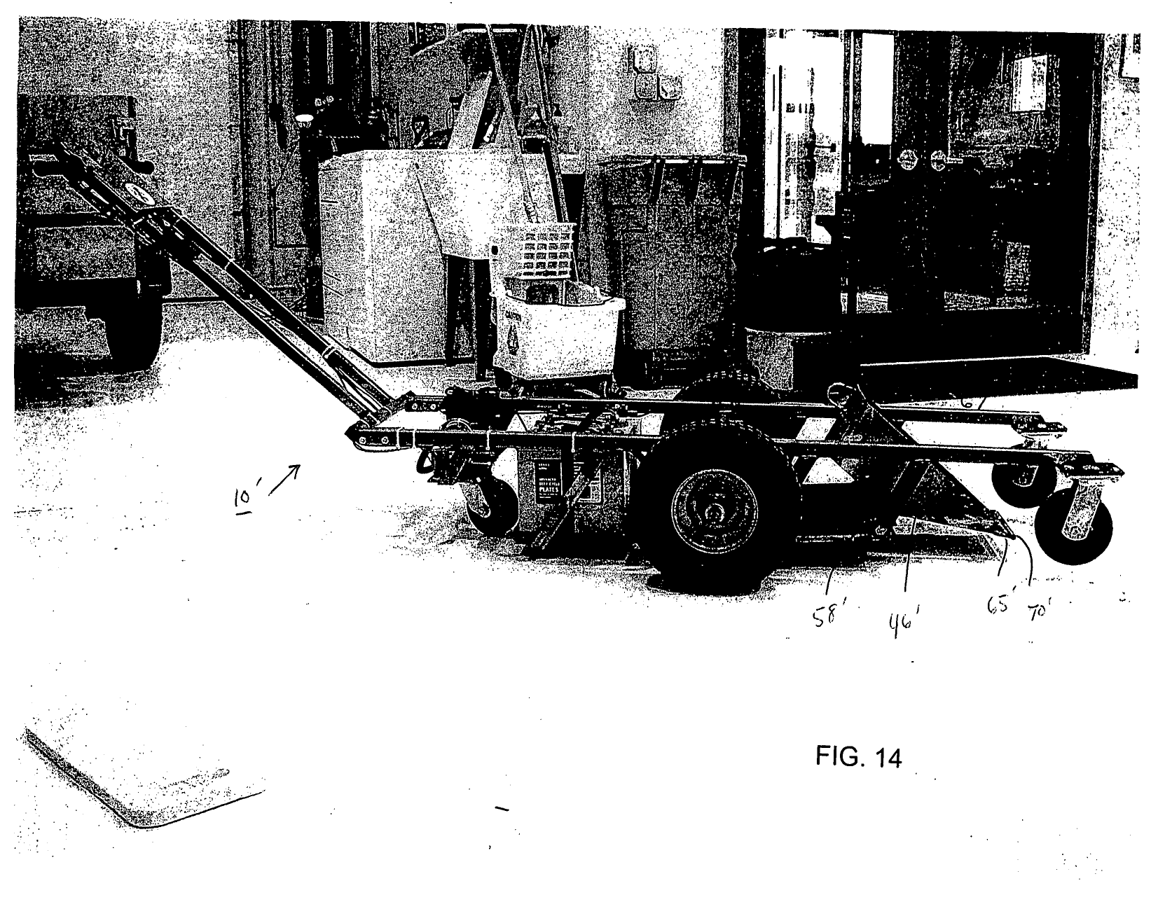

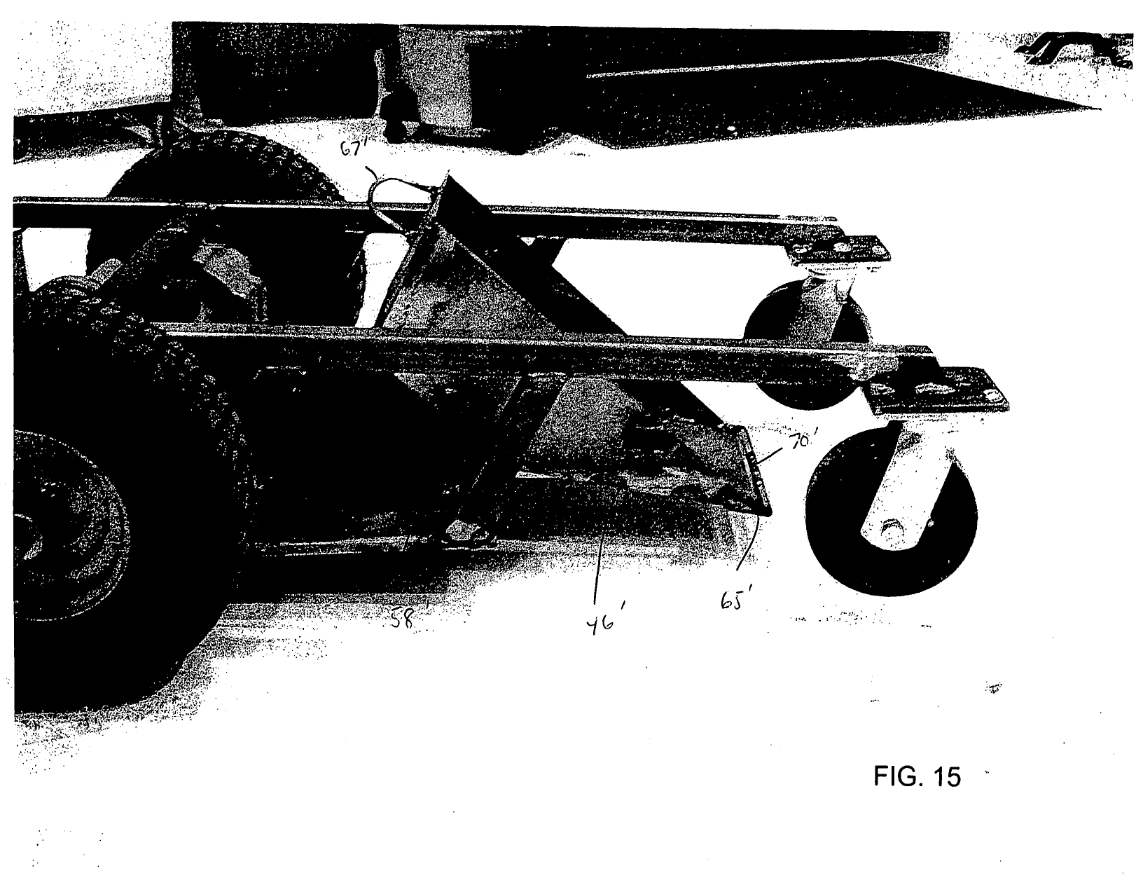

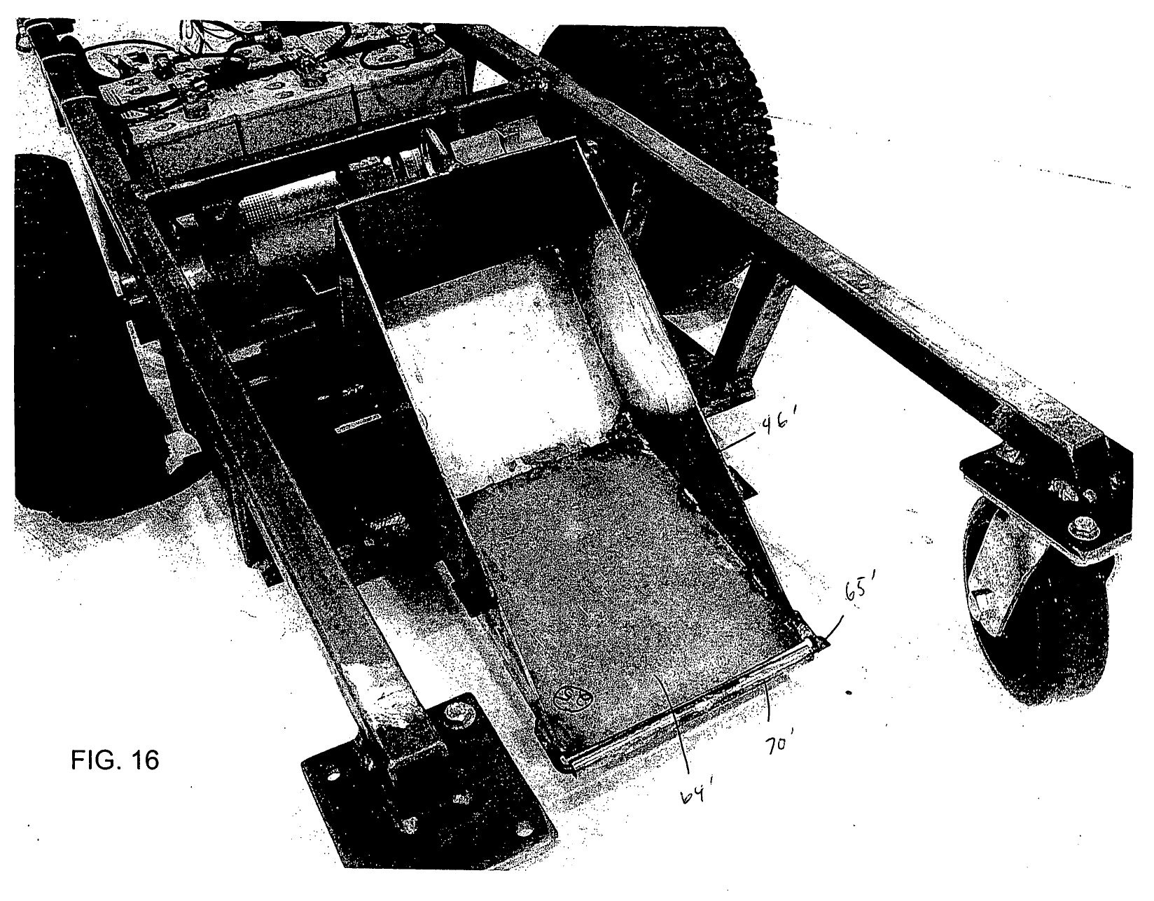

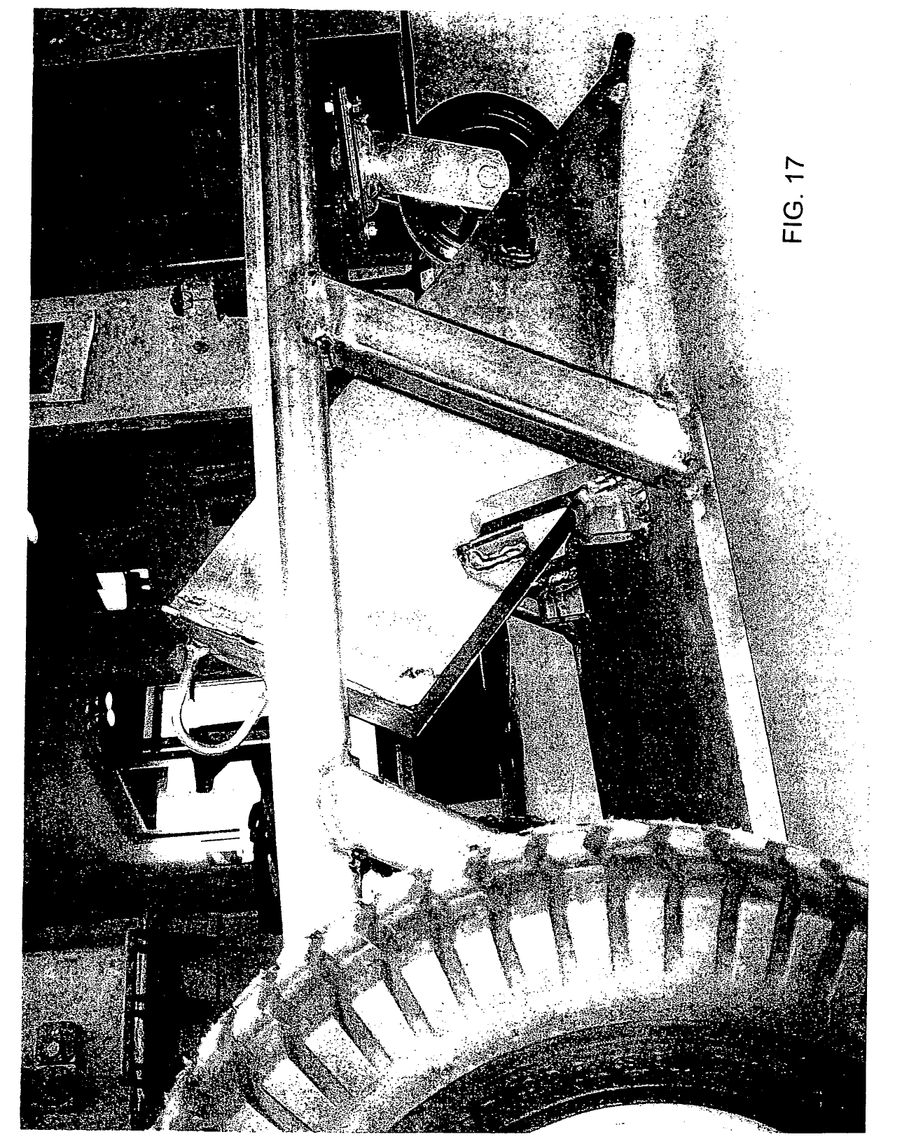

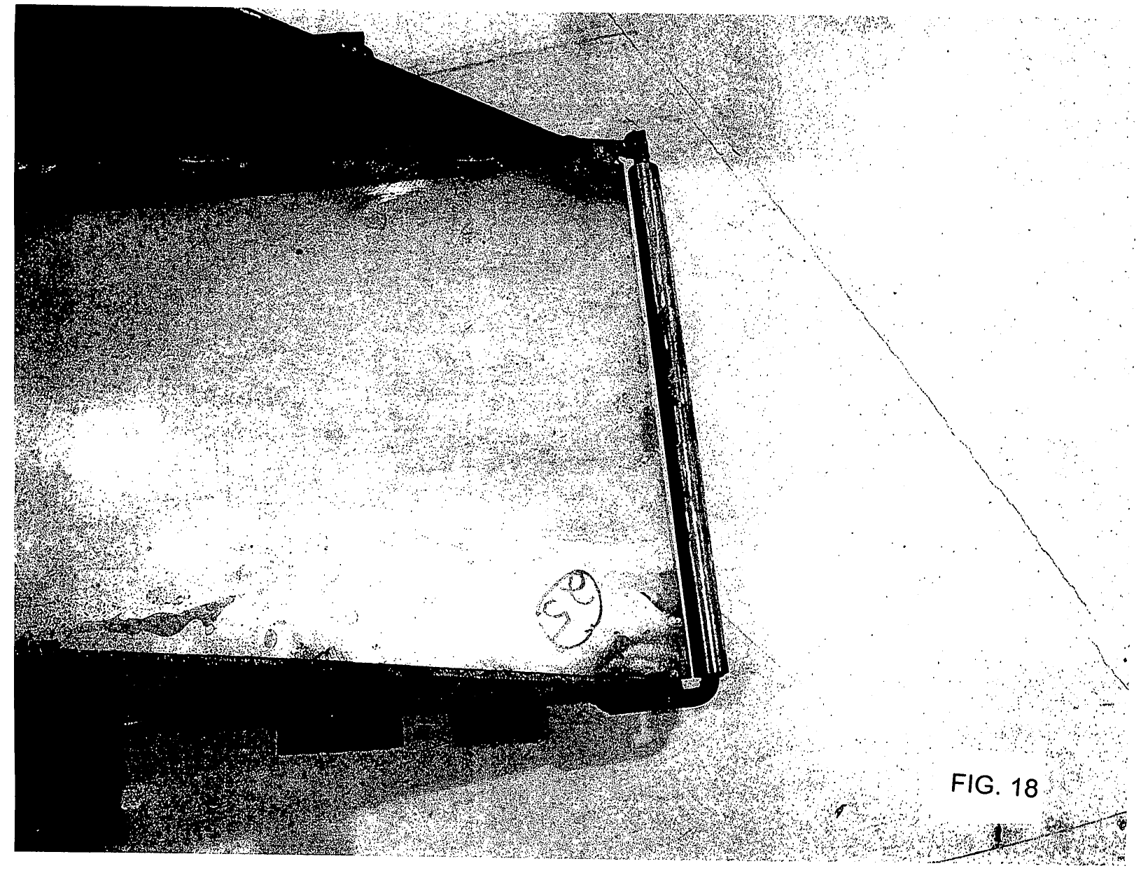

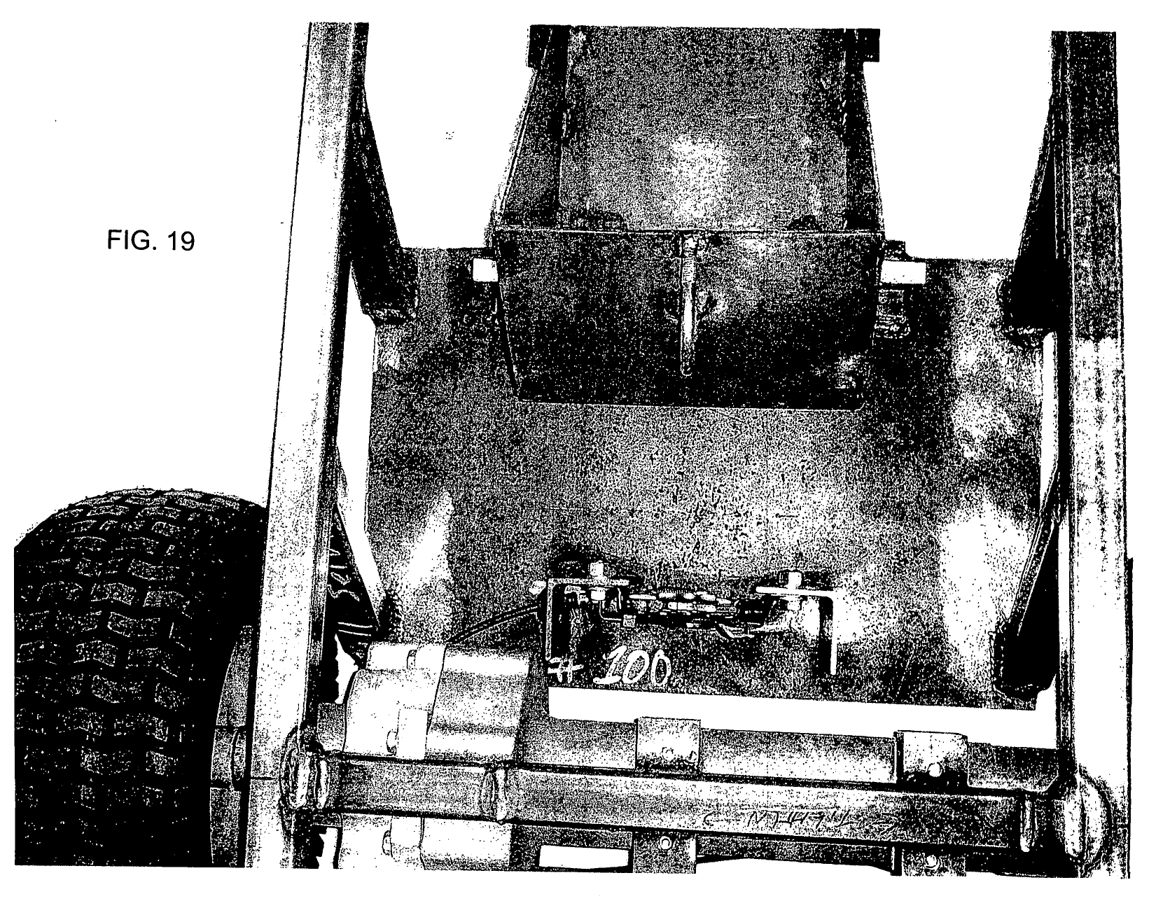

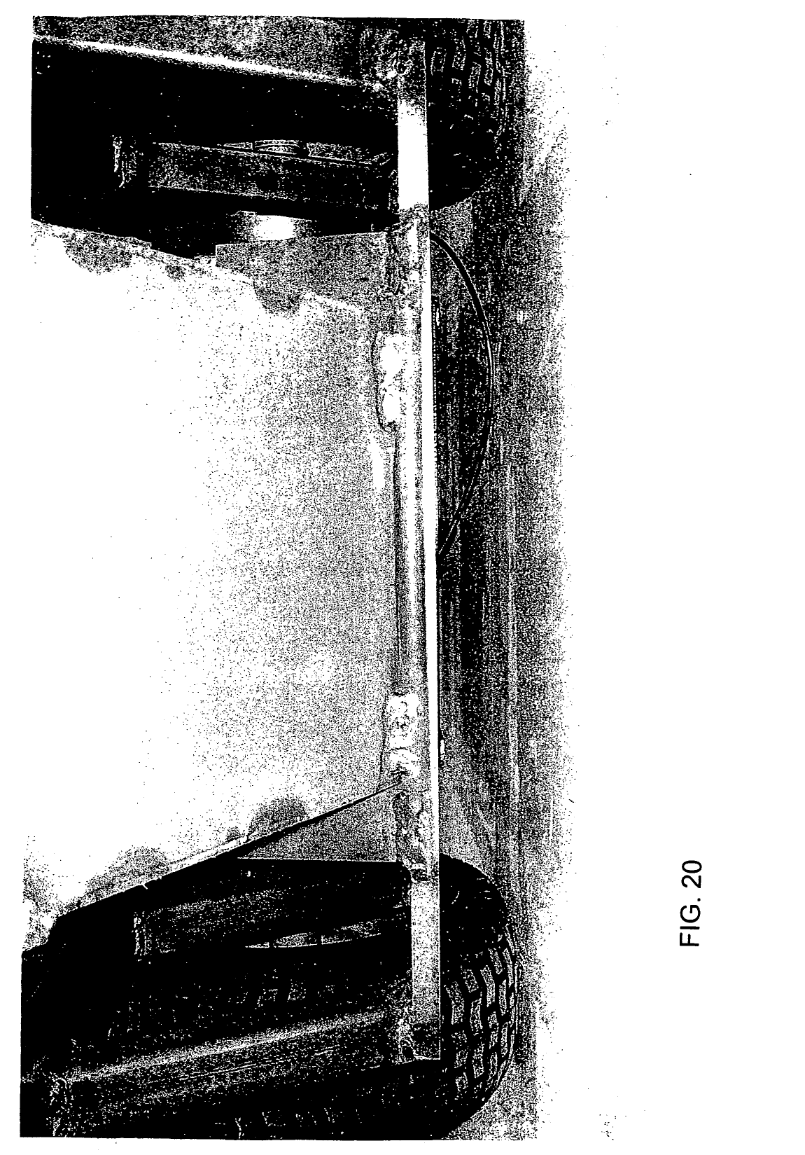

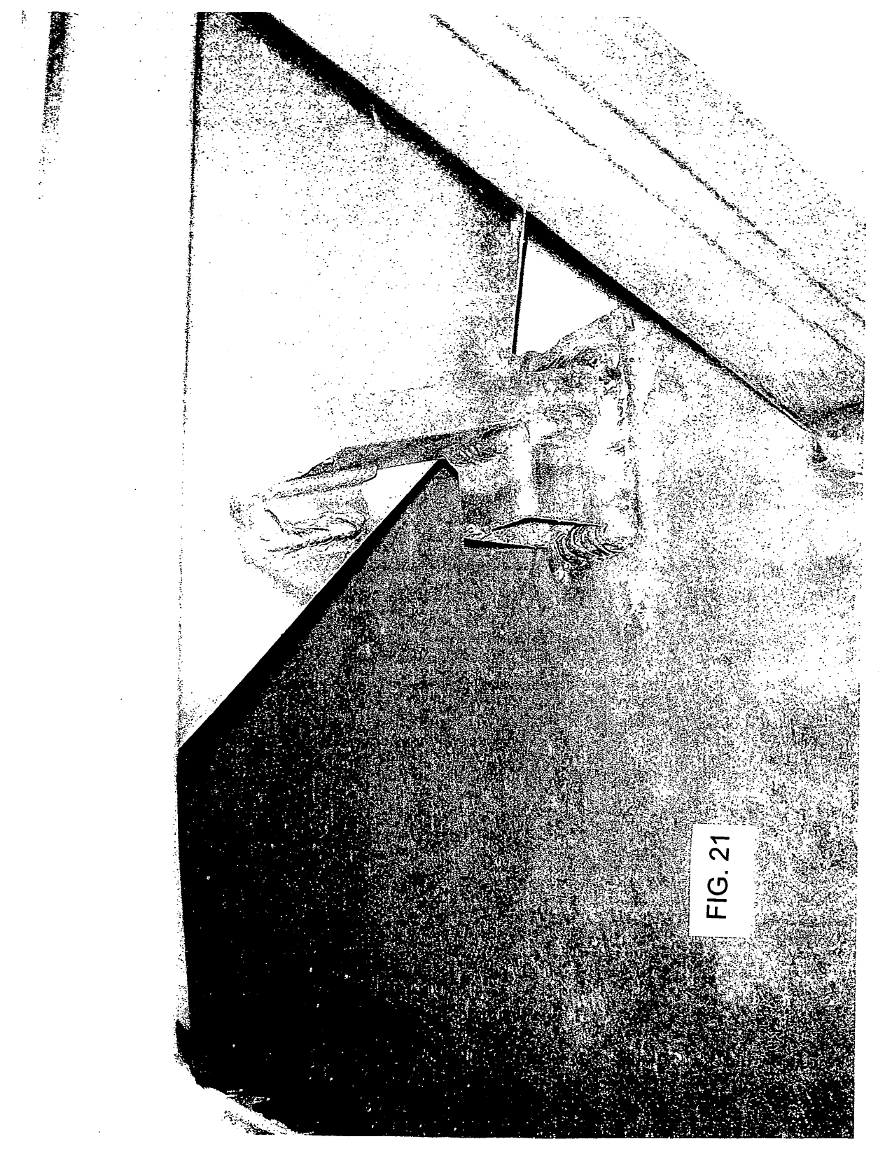

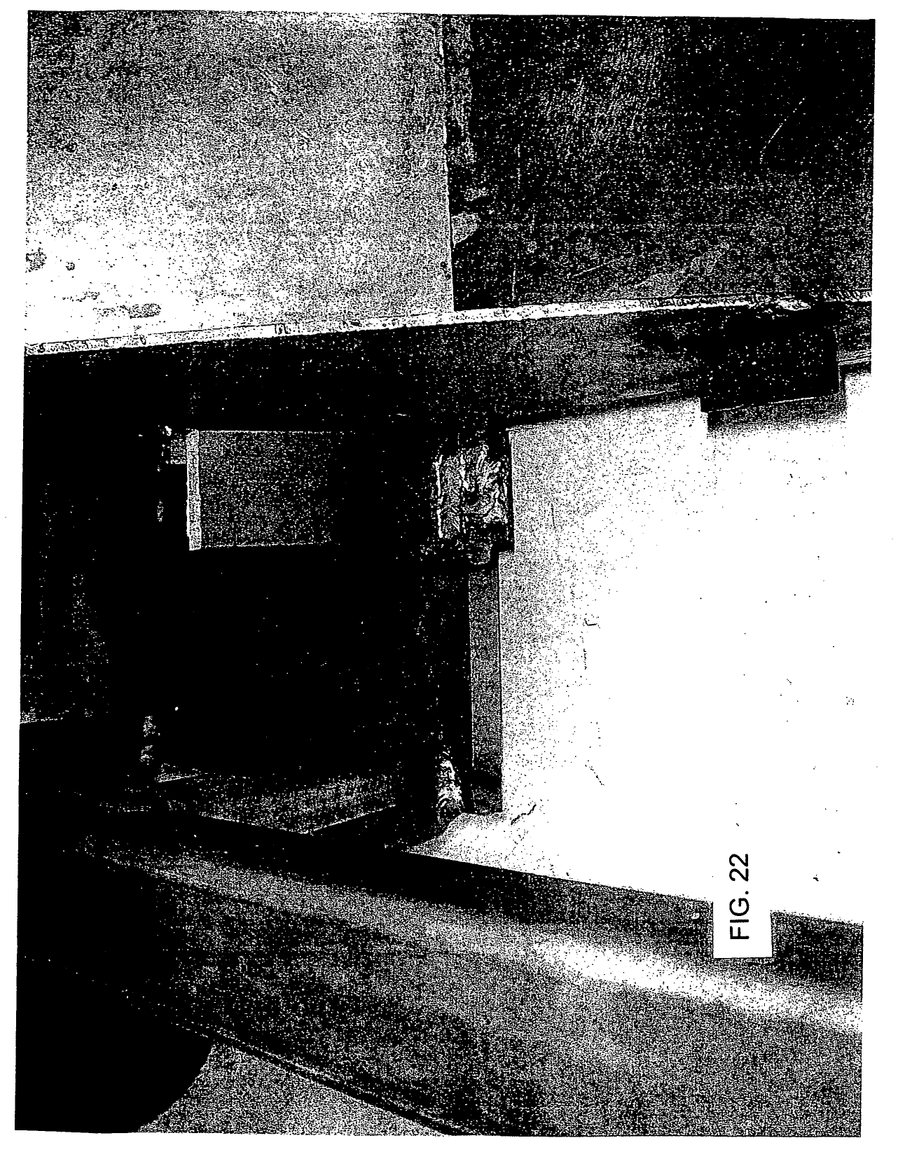

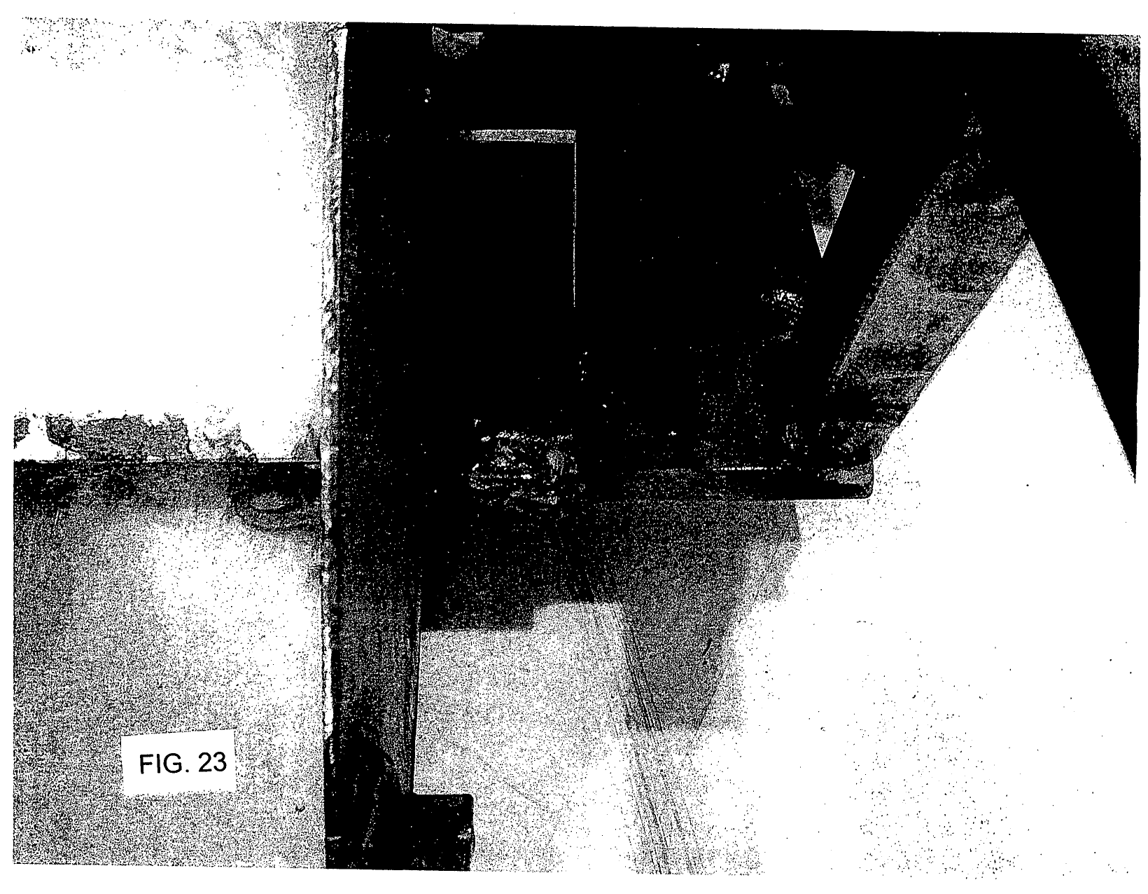

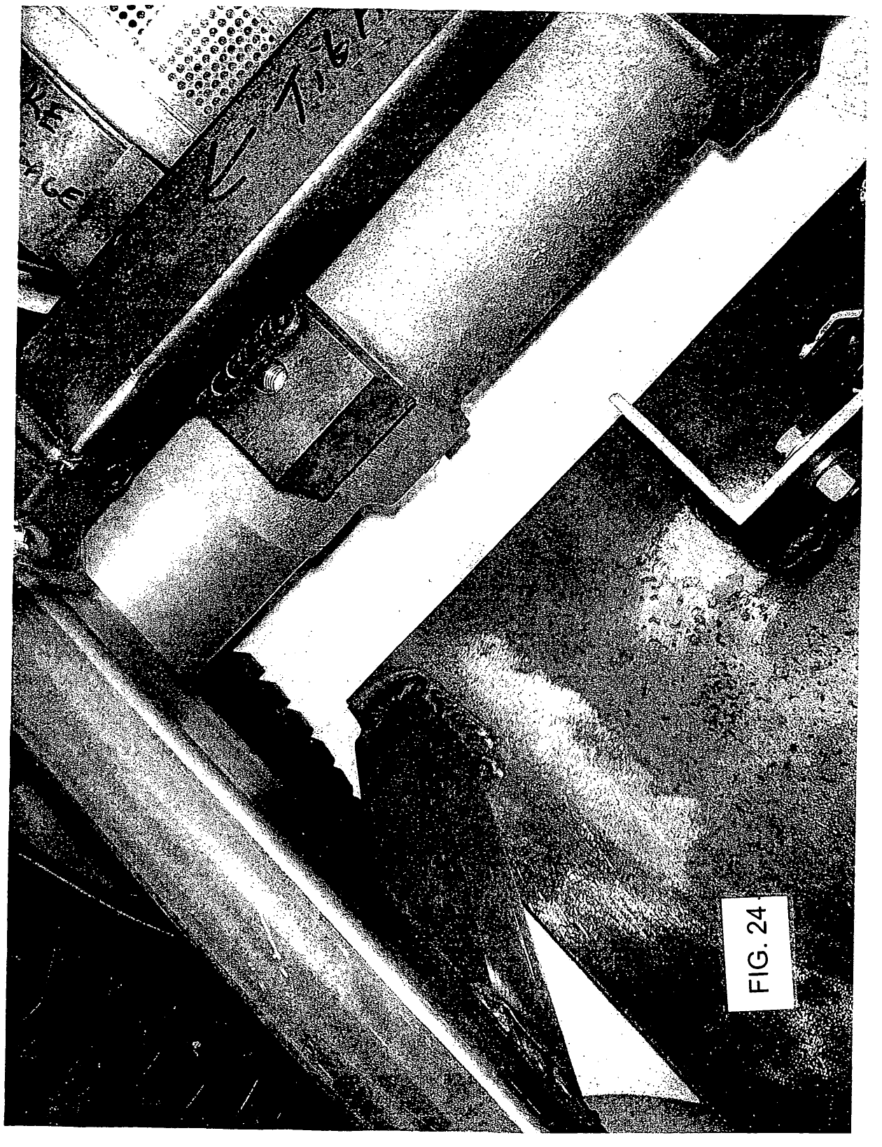

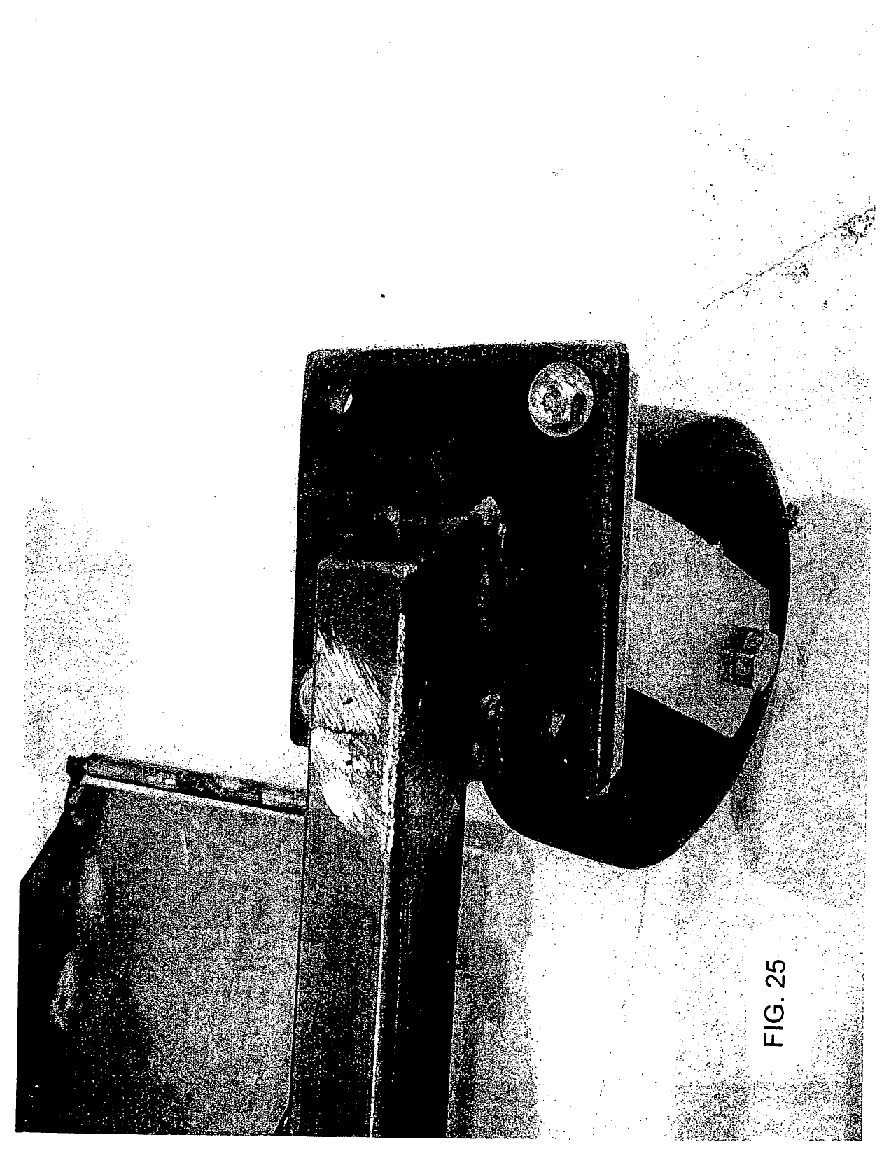

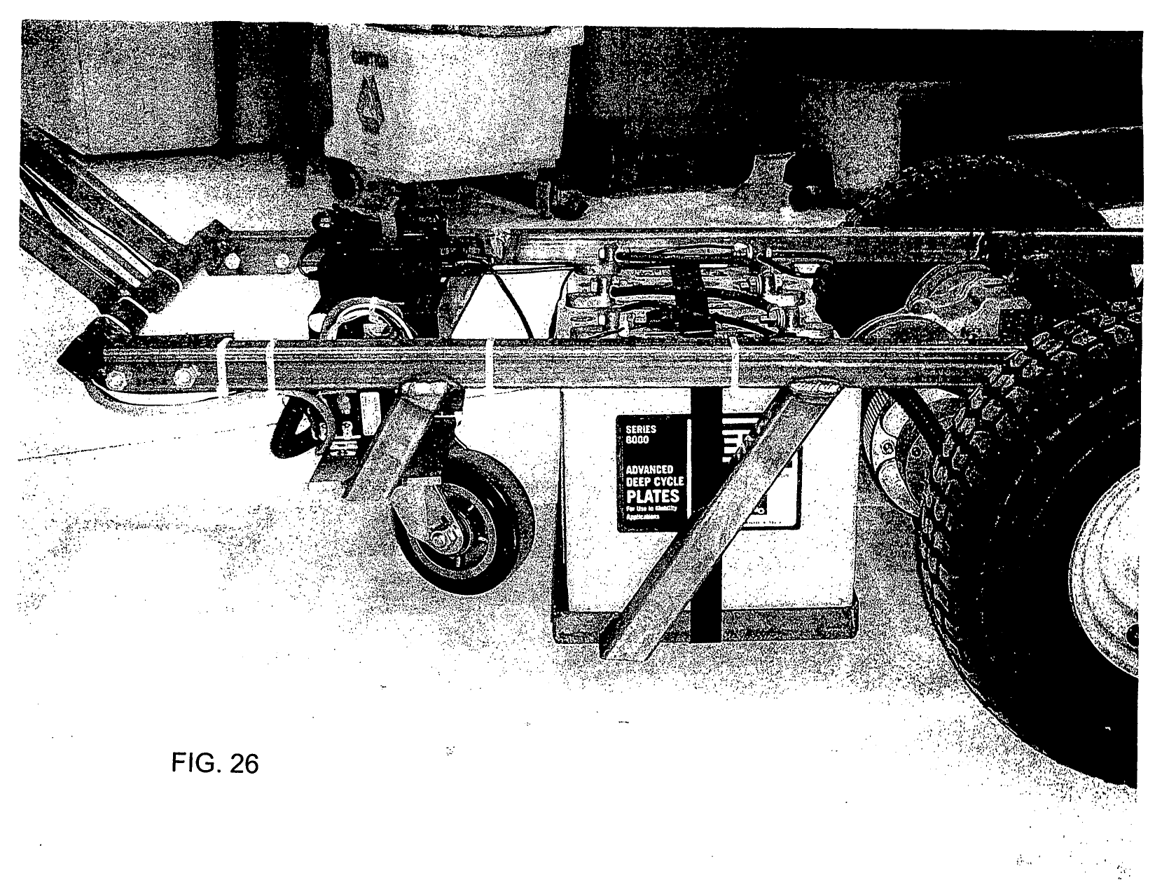

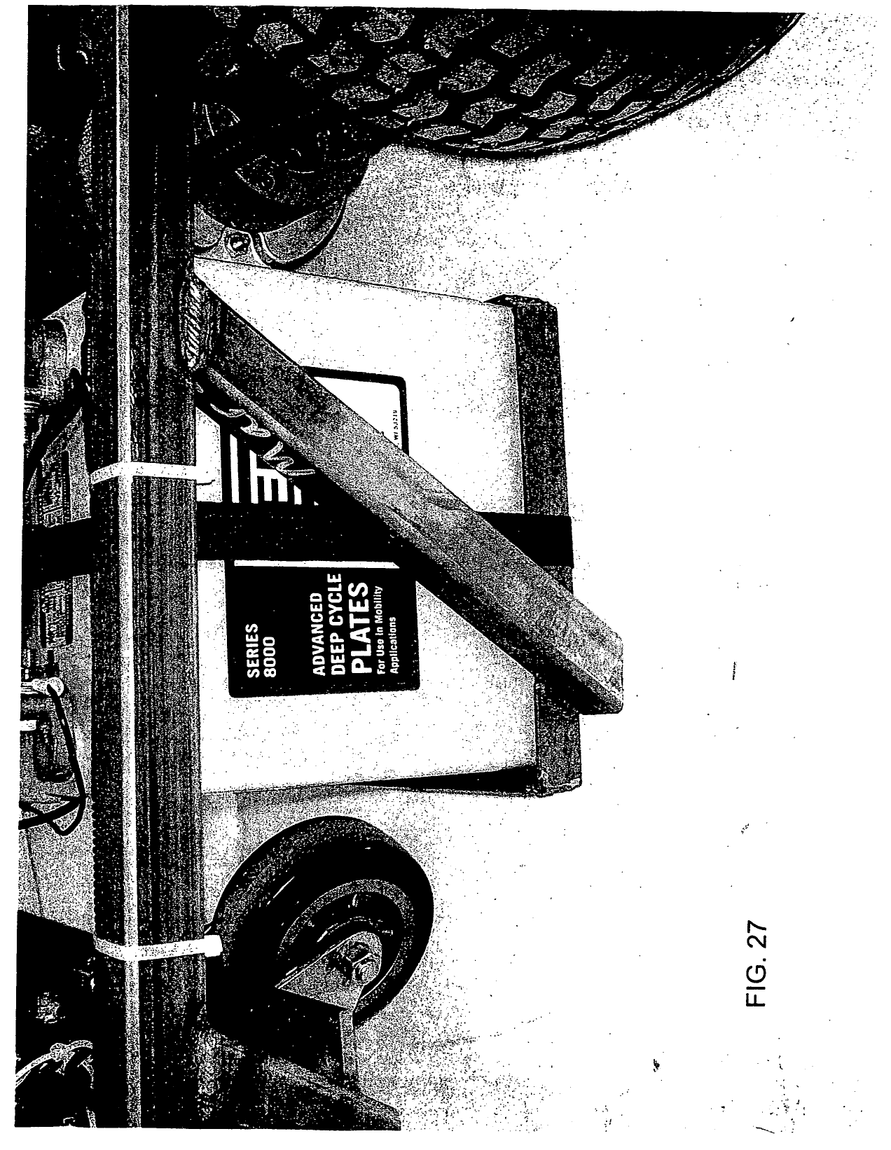

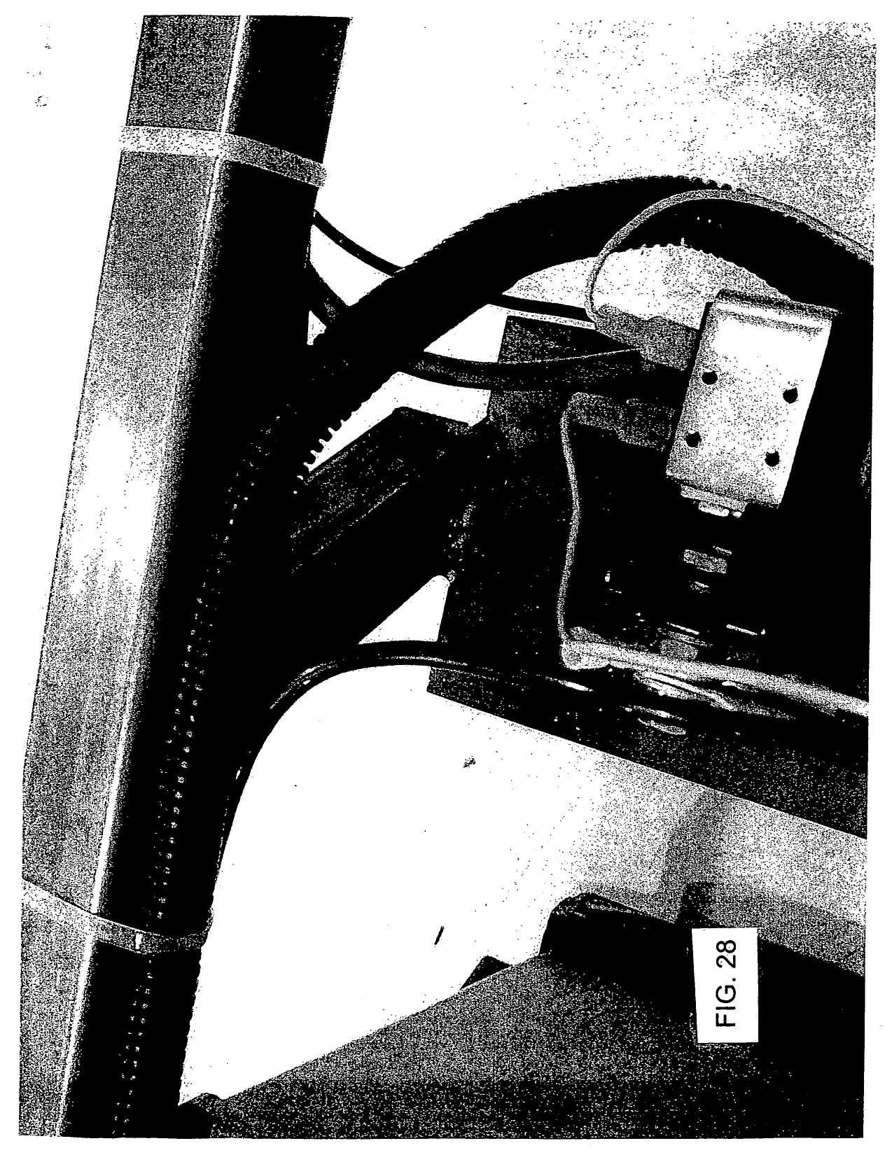

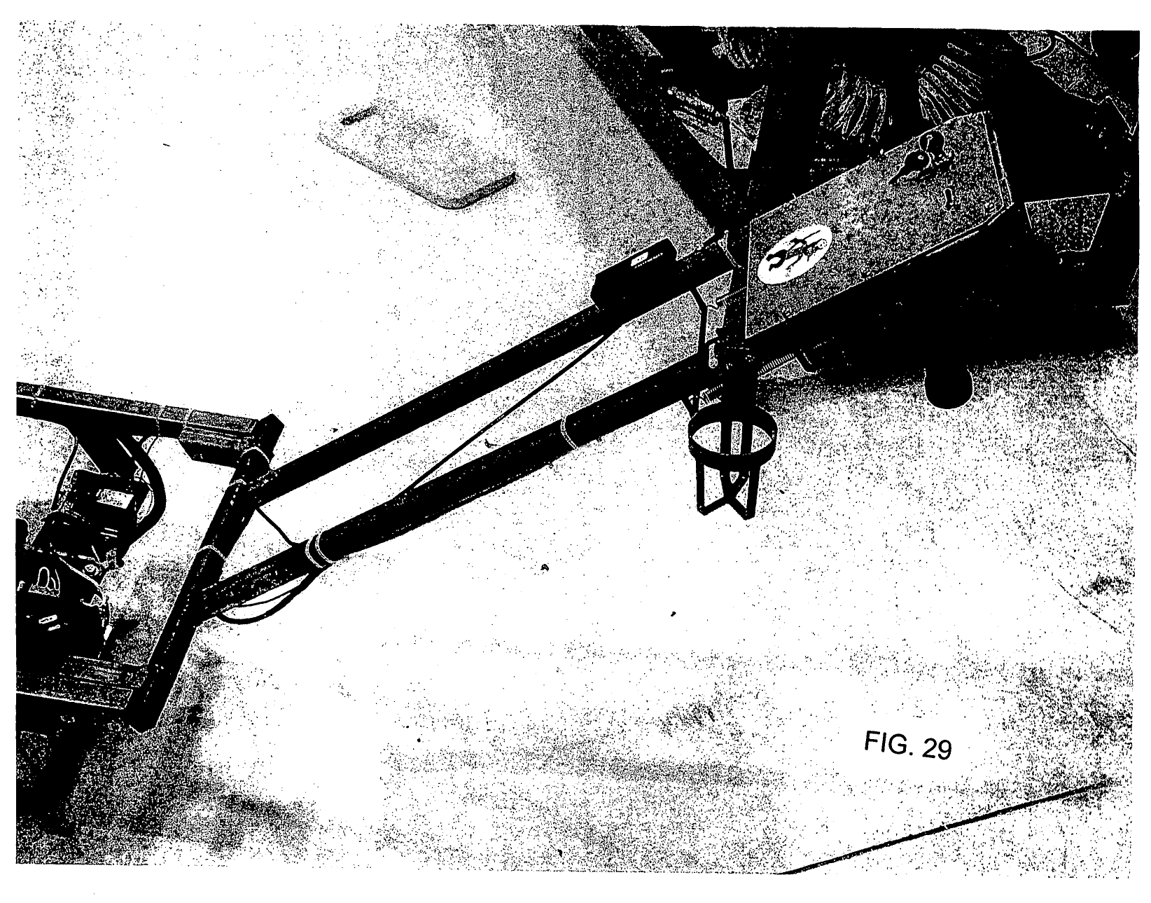

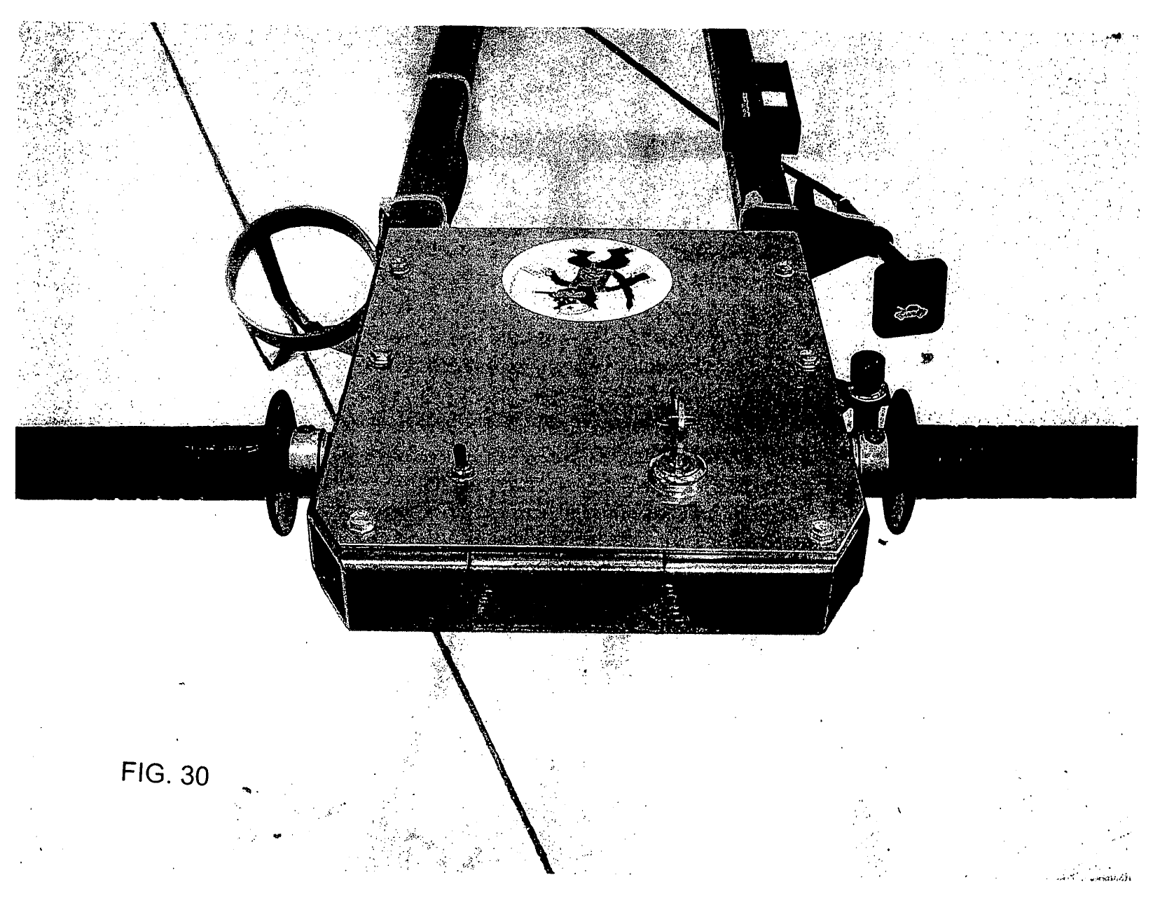

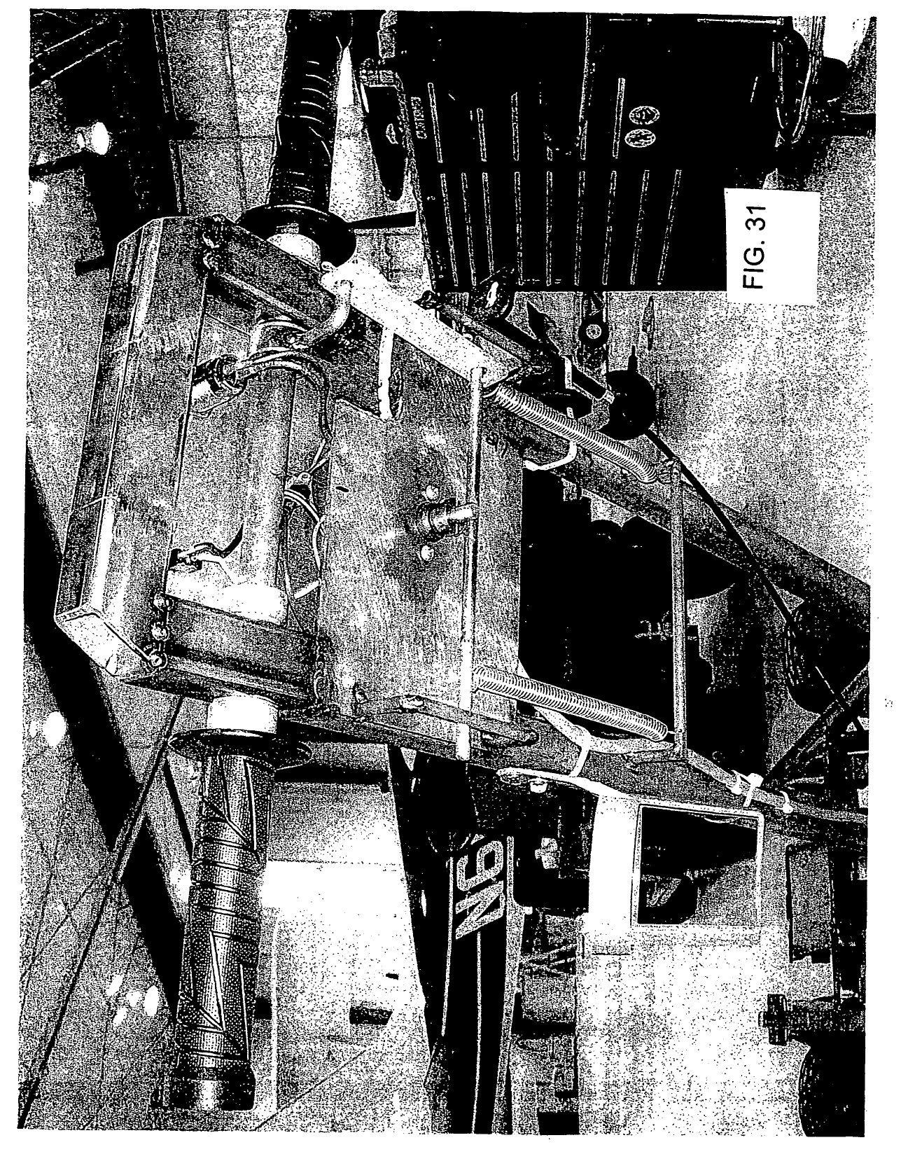

FIGS. 13-31 illustrate an alternative construction for a tug 10′. Common elements have the same reference number “”.

As described above, the invention may provide, among other things, a self propelled vehicle used to move aircraft. The vehicle may include a tilting bucket mechanism which forms a ramp to load the aircraft nose wheel or tail wheel, and which rotates to latch securely into position for vehicle movement. The bucket may be supported in the loading position so as to come very close to ground level without touching. The bucket may be hinged at its base so as to from a see-saw type ramp for loading, raising, and capturing the aircraft nose or tail wheel as that wheel's center of gravity moves beyond the hinged fulcrum of the bucket base. The bucket may incorporate a latching/unlatching mechanism that automatically latches to secure the bucket assembly in its upright (loaded) position for aircraft pushing/pulling. The latch may be remotely released by the operator for unloading.

One or more independent advantages and/or independent features of the invention may be set forth in the following claims:

What is claimed is:

1. A tug operable to move an airplane, the airplane including an airplane wheel, the tug comprising:
a frame;
a wheel supporting the frame for movement over ground; and
a retainer assembly supported by the frame and engageable with the airplane wheel to connect the tug and the airplane, the retainer assembly being configurable in a loading condition, in which the airplane wheel is loaded onto and off of the tug, and in a retaining condition, in which the airplane wheel is retained on the tug, the retainer assembly including
a first wall engageable with a front portion of the airplane wheel to limit movement of the airplane wheel relative to the tug in the direction of the first wall, and
a second wall positionable in an engaging position, in which the second wall is engageable with a rear portion of the airplane wheel to limit movement of the airplane wheel relative to the tug in the direction of the second wall, and in a ramp position, in which the second wall provides a ramp portion, the airplane wheel being movable on the ramp portion onto and off of the tug.

2. The tug of claim 1, wherein the retainer assembly includes a bucket assembly providing the first wall and the second wall, the bucket assembly also including side walls extending from the first wall and toward the second wall, the side walls limiting movement of the airplane wheel in a lateral direction.

3. The tug of claim 2, wherein the side walls are connected between the first wall and the second wall.

4. The tug of claim 1, wherein the retainer assembly includes a bucket assembly providing the first wall and the second wall, the bucket assembly being supported by the frame for pivoting movement between a loading position, in which the second wall is positioned in the ramp position such that the airplane wheel is loadable onto and off of the tug, and a retaining position, in which the second wall is positioned in the engaging position such that the airplane wheel is retained on the tug.

5. The tug of claim 4, wherein the retainer assembly includes a hinge assembly pivotally supporting the bucket assembly.

6. The tug of claim 5, wherein the hinge assembly defines a pivot axis, the pivot axis being located relative to the frame such that movement of the airplane wheel on the second wall causes movement of the bucket assembly between the loading position and the retaining position.

7. The tug of claim 4, wherein the tug is movable over a surface, and wherein, in the ramp position, the second wall is maintained substantially out of contact with the surface.

8. The tug of claim 7, wherein, in the loading position, a portion of the bucket assembly is engageable with a portion of the frame to substantially prevent engagement of the second wall with the surface.

9. The tug of claim 4, wherein, in the ramp position, the second wall has a leading edge, and wherein the bucket assembly further includes a roller member supported proximate the leading edge and engageable with the airplane wheel to facilitate movement of the airplane wheel onto the ramp portion.

10. The tug of claim 4, and further comprising a latch mechanism operable to hold the bucket assembly in the retaining position.

11. The tug of claim 10, wherein the latch mechanism includes
a first latch member supported by the frame, and
a second latch member supported by the bucket assembly, one of the first latch member and the second latch member being movable between a holding position, in which the first latch member and the second latch member are engageable to hold the bucket in the retaining position, and a release position, in which the first latch member and the second latch member are disengageable to allow movement of the bucket assembly at least from the retaining position.

12. The tug of claim 11, and further comprising a release mechanism operable to move the one of the first latch member and the second latch member at least from the holding position to the release position.

13. The tug of claim 12, and further comprising an operator's handle extending from the frame and supported for engagement by an operator in an upright position, and wherein the release mechanism includes a release handle engageable by the operator to cause operation of the release mechanism, the release handle being supported proximate the operator's handle.

14. The tug of claim 1, and further comprising a motor assembly supported by the frame, the motor assembly including
a motor supported by the frame and drivingly connected to the wheel to cause movement of the tug over ground,
a power source supported by the frame and operable to power the motor, and
a motor operation handle extending from the frame and supported for engagement by an operator in an upright position, the motor operation handle being engageable by an operator to operate the motor.

15. The tug of claim 14, wherein the motor assembly further includes a motor controller connected to the motor and operable to control operation of the motor, the motor controller being programmable to provide motor operation characteristics.

16. A tug operable to move an airplane, the airplane including an airplane wheel, the tug being movable over a surface, the tug comprising:
a frame;
a wheel supporting the frame for movement over ground; and
a retainer assembly supported by the frame and engageable with the airplane wheel to connect the tug and the airplane, the retainer assembly being configurable in a loading condition, in which the airplane wheel is loaded onto and off of the tug, and in a retaining condition, in which the airplane wheel is retained on the tug, the retainer assembly including
a first wall engageable with a front portion of the airplane wheel to limit movement of the airplane wheel relative to the tug in the direction of the first wall, and
a second wall positionable in an engaging position, in which the second wall is engageable with a rear portion of the airplane wheel to limit movement of the airplane wheel relative to the tug in the direction of the second wall, and in a ramp position, in which the second wall provides a ramp portion, the airplane wheel being movable on the ramp portion onto and off of the tug, the second wall being maintained substantially out of contact with the surface in the ramp position.

17. The tug of claim 16, wherein, in the loading position, a portion of the retainer assembly is engageable with a portion of the frame to substantially prevent engagement of the second wall with the surface.

18. The tug of claim 16, wherein, in the ramp position, the second wall has a leading edge, and wherein the retainer assembly further includes a roller member supported proximate the leading edge and engageable with the airplane wheel to facilitate movement of the airplane wheel onto the ramp portion.

19. The tug of claim 16, and further comprising a latch mechanism operable to hold the retainer assembly in the retaining condition.

20. A tug operable to move an airplane, the airplane including an airplane wheel, the tug being movable over a surface, the tug comprising:
a frame;
a wheel supporting the frame for movement over ground;
a bucket assembly pivotally supported by the frame and engageable with the airplane wheel to connect the tug and the airplane, the bucket assembly being pivotable between a loading condition, in which the airplane wheel is loaded onto and off of the tug, and a retaining condition, in which the airplane wheel is retained on the tug, the bucket assembly including
a first wall engageable with a front portion of the airplane wheel to limit movement of the airplane wheel relative to the tug in the direction of the first wall, and
a second wall positionable in an engaging position, in which the second wall is engageable with a rear portion of the airplane wheel to limit movement of the airplane wheel relative to the tug in the direction of the second wall, and in a ramp position, in which the second wall provides a ramp portion, the airplane wheel being movable on the ramp portion onto and off of the tug;
a latch mechanism operable to hold the bucket assembly in the retaining position, the latch mechanism including
a first latch member supported by the frame, and
a second latch member supported by the bucket assembly, one of the first latch member and the second latch member being movable between a holding position, in which the first latch member and the second latch member are engageable to hold the bucket in the retaining position, and a release position, in which the first latch member and the second latch member are disengageable to allow movement of the bucket assembly at least from the retaining position; and
a release mechanism operable to move the one of the first latch member and the second latch member at least from the holding position to the release position.
